(19) United States
(12) Patent Application Publication
(10) Pub. No.: US 2009/0068576 A1
(43) Pub. Date: Mar. 12, 2009

(54) Gallium phthalocyanine crystal, production process thereof, photoreceptor, process cartridge and image forming apparatus

(75) Inventors: Kazuya Hongo, Kanagawa (JP); Tetsuo Ohta, Kanagawa (JP); Akira Hirano, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., MINATO-KU (JP)

(21) Appl. No.: 12/076,185

(22) Filed: Mar. 14, 2008

(30) Foreign Application Priority Data
Sep. 7, 2007 (JP) 2007-232485

(51) Int. Cl. G03C 1/73; G03G 15/00; C09B 47/04

(52) U.S. Cl. 430/57.1; 540/141; 399/159

(57) ABSTRACT

A gallium phthalocyanine crystal has a peak of spectral absorption spectrum within a wavelength range of from about 760 nm to about 773 nm or within a wavelength range of from about 790 nm to about 809 nm.

### CROSS-REFERENCE TO RELATED APPLICATIONS

This application is based on and claims priority under 35 USC 119 from Japanese Patent Application No. 2007-232485 filed on Sep. 7, 2007.

### BACKGROUND

1. Technical Field

The present invention relates to a gallium phthalo-cyanine crystal, a production process thereof, a process cartridge and an image forming apparatus.

2. Related Art

As for the photoreceptor used in an image forming apparatus such as copier, printer and digital complex machine, a photoreceptor using an organic photoelectrically conductive material as the charge generating material is predominating at present. The photoreceptor using an organic photoelectrically conductive material is effective in view of environmental pollution control measure and has advantages such as high productivity and low cost.

### SUMMARY

According to an aspect of the invention, there is provided a gallium phthalocyanine crystal having a peak of spectral absorption spectrum within a wavelength range of from about 760 nm to about 773 nm or within a wavelength range of from about 790 nm to about 809 nm.

### BRIEF DESCRIPTION OF THE DRAWINGS

Exemplary embodiment(s) of the present invention will be described in detail based on the following figures, wherein:

FIG. 1 illustrates a schematic construction view showing one example of the apparatus having a microreactor suitably used for the production process of a gallium phthalocyanine crystal in an exemplary embodiment of the present invention;

FIG. 2 illustrates a schematic construction view showing one example of the apparatus having a double-tube microreactor suitably used for the production process of a gallium phthalocyanine crystal in an exemplary embodiment of the present invention;

FIG. 3 illustrates an enlarged schematic view of the double-tube microreactor used in FIG. 2;

FIG. 4 illustrates a cross-sectional view showing a first exemplary embodiment of the photoreceptor in an exemplary embodiment of the present invention;

FIG. 5 illustrates a cross-sectional view showing a second exemplary embodiment of the photoreceptor in an exemplary embodiment of the present invention;

FIG. 6 illustrates a cross-sectional view showing a third exemplary embodiment of the photoreceptor in an exemplary embodiment of the present invention;

FIG. 7 illustrates a cross-sectional view showing a fourth exemplary embodiment of the photoreceptor in an exemplary embodiment of the present invention;

FIG. 8 illustrates a cross-sectional view schematically showing the basic construction in one preferred exemplary embodiment of the image forming apparatus in an exemplary embodiment of the present invention;

FIG. 9 illustrates a cross-sectional view schematically showing the basic construction in another exemplary embodiment of the image forming apparatus in an exemplary embodiment of the present invention shown in FIG. 8;

FIG. 10 illustrates a cross-sectional view schematically showing the basic construction of a full color printer which is one of the image forming apparatus in an exemplary embodiment of the present invention;

FIG. 11 illustrates a cross-sectional view schematically showing the basic construction in one preferred exemplary embodiment of the process cartridge in an exemplary embodiment of the present invention;

FIG. 12 illustrates a powder X-ray diffraction pattern of the II-type chlorogallium phthalocyanine crystal in an exemplary embodiment of the present invention obtained in Example 1;

FIG. 13 illustrates a spectral absorption spectrum of the II-type chlorogallium phthalocyanine crystal of the present invention obtained in Example 1.

FIG. 14 illustrates an enlarged schematic view showing the vicinity of the end 72 of the channel L6 in FIGS. 2 and 3;

FIG. 15 illustrates a powder X-ray diffraction pattern of the V-type hydroxygallium phthalocyanine crystal in an exemplary embodiment of the present invention obtained in Example 3; and

FIG. 16 illustrates a spectral absorption spectrum of the V-type hydroxygallium phthalocyanine crystal in an exemplary embodiment of the present invention obtained in Example 3,

wherein 1 denotes photoreceptor, 2 denotes electrically conductive substrate, 3 denotes photosensitive layer, 4 denotes subbing layer, 5 denotes photosensitive layer (charge generating layer), 6 denotes photosensitive layer (charge transport layer), 7 denotes protective layer, 8 denotes intermediate layer, 10 denotes apparatus, 12 and 16 denotes tank, 14 denotes first fluid, 18 denotes second fluid, 20 denotes microreactor, 22 denotes mixed solution, 24 denotes vessel, 26 denotes heater, 28 denotes temperature control unit, 40 denotes apparatus, 42 and 54 denote tank, 44 and 58 denote jacket for temperature control, 46 denotes first fluid, 48 denotes rotation drive mechanism, 50 denotes rotating shaft, 52 denotes stirring blade, 56, second fluid, 60 denotes double-tube microreactor, 62 denotes connection part, 64 denotes first channel forming member, 66 denotes second channel forming member, 68 denotes mixed solution, 70 denotes vessel, 72 denotes valve for adjusting discharge velocity, 74 denotes end of channel L6, 76 denotes end of connection part, 78 denotes end of channel L8, 200 and 220 denote image forming apparatus, 207 denotes photoreceptor, 208 denotes electrically charging device, 209 denotes power source, 210 denotes exposure device, 211 denotes developing device, 212 denotes transfer device, 213 denotes cleaning device, 214 denotes destaticizer, 215 denotes fixing device, 216 denotes attaching rail, 217 denotes opening for destaticization and exposure, 218 and 219 denote opening for exposure, 300 denote process cartridge, 400 denotes housing, 401a, 401b, 401c and 401d denote photoreceptor, 402a, 402b, 402c and 402d denote electrically charging roll, 403 denotes laser source (exposure device), 404a, 404b, 404c and 404d denote developing device, 405a, 405b, 405c and 405d denote toner cartridge, 406 denotes drive roll, 407 denotes tension roll, 408 denotes backup roll, 409 denotes intermediate transfer belt, 410a, 410b, 410c and 410d denote primary transfer roll, 411 denotes tray (recording medium tray), 412 denotes conveying roll, 413 denotes secondary transfer roll, 414 denotes fixing roll, 415a, 415b, 415c and 415d denote cleaning blade, 416, cleaning blade, 500 denotes recording medium, H1 denotes length from end 76 of connection part to end 74 of channel L6, H2 denotes length from end 76 of connection part to end 78 of channel L8, L1, L2, L3, L4, L5, L6, L7 and L8 denote channel, and P1, P2, P3 and P4 denote liquid feed pump.

### DETAILED DESCRIPTION

The gallium phthalocyanine crystal in an exemplary embodiment of the present invention has a peak in the wavelength range of from about 760 nm to about 773 nm or in the wavelength range of from about 790 nm to about 809 nm of the spectral absorption spectrum.

The process for producing a gallium phthalocyanine crystal in an exemplary embodiment of the present invention includes a solution preparing step of dissolving a gallium phthalocyanine compound in a good solvent to prepare a solution, and a crystal forming step of mixing a bad solvent for the gallium phthalocyanine compound with the solution in a microchannel to obtain a crystal of the gallium phthalocyanine compound.

The exemplary embodiments of the present invention are described in detail below by referring to the drawings.

### (Gallium Phthalocyanine Crystal)

The gallium phthalocyanine crystal in an exemplary embodiment of the present invention has a peak in the wavelength range of from about 760 nm to about 773 nm or in the wavelength range of from about 790 nm to about 809 nm of the spectral absorption spectrum.

The gallium phthalocyanine crystal in this exemplary embodiment is suitable as a charge generating material.

The spectral absorption spectrum of the gallium phthalocyanine crystal in this exemplary embodiment can be measured by a known method. Specific preferred examples thereof include a method of ultrasonically dispersing 1 mg of a gallium phthalocyanine crystal in 1 mL of acetone at room temperature (25° C.) to prepare a measurement solution, and measuring it by using a spectrophotometer, Model U-2000, manufactured by Hitachi, Ltd.

The wavelength range in which the spectral absorption spectrum is measured may be sufficient if it is a range enabling to measure whether a peak is present in a predetermined wavelength range or not, but a range of 600 to 900 nm is preferred. The predetermined wavelength range is a wavelength range of from about 760 nm to about 773 nm or a wavelength range of from about 790 nm to about 809 nm. Specifically, the predetermined wavelength range is from about 760 nm to about 773 nm in the case of a II-type chlorogallium phthalocyanine crystal and from about 790 nm to about 809 nm in the case of a V-type hydroxygallium phthalocyanine crystal.

In the gallium phthalocyanine crystal of this exemplary embodiment, the peak in the wavelength range above is preferably a first or second largest peak, more preferably a second largest peak, in the range of from about 600 nm to about 900 nm.

The particle diameter (median diameter (diameter at the center)) of the gallium phthalocyanine crystal of this exemplary embodiment is preferably from about 10 nm to about 300 nm, more preferably from about 15 nm to about 250 nm.

Also, GSD_{V} of the gallium phthalocyanine crystal of this exemplary embodiment is preferably from about 1.0 to about 3.0, more preferably from about 1.0 to about 2.5.

Incidentally, assuming that the particle diameter giving a volume accumulation of 16% when a cumulative distribution is drawn from a small particle diameter with respect to particle size ranges (channels) created by dividing the particle size distribution measured is the volume D₁₆ᵥ and the particle diameter giving a volume accumulation of 84% is the volume D_{84V}, the volume average particle size distribution GSD_{V} is a value determined by D_{84V}/D_{16V}.

### (II-Type Chlorogallium Phthalocyanine Crystal)

The II-type chlorogallium phthalocyanine crystal in an exemplary embodiment of the present invention has a peak in the wavelength range of 760 to 773 nm of the spectral absorption spectrum.

The II-type chlorogallium phthalocyanine crystal of this exemplary embodiment is suitable as a charge generating material.

The measurement of the spectral absorption spectrum of the II-type chlorogallium phthalocyanine crystal in this exemplary embodiment is the same as the measurement of the spectral absorption spectrum of the above-described gallium phthalocyanine crystal.

In the II-type chlorogallium phthalocyanine crystal of this exemplary embodiment, the peak in the wavelength range of from about 760 nm to about 773 nm is preferably a first or second largest peak, more preferably a second largest peak, in the range of 600 to 900 nm.

When the chlorogallium phthalocyanine crystal has a II-type crystal form, this can be confirmed by having a diffraction peak at least at 7.4°, 16.6°, 25.5° and 28.3° of the Bragg angle (2θ±0.2°) in the X-ray diffraction spectrum measured using a CuKα characteristic X-ray.

Examples of the raw material of the II-type chlorogallium phthalocyanine crystal in this exemplary embodiment include I-type chlorogallium phthalocyanine.

The I-type chlorogallium phthalocyanine which can be used in this exemplary embodiment is not particularly limited and may be synthesized by a known method but can be synthesized, for example, by a known method such as diiminoisoindoline process of heating and condensing 1,3-diiminoisoindoline with gallium trichloride in an organic solvent.

The I-type chlorogallium phthalocyanine synthesized by the method above has a diffraction peak at 27.1° of the Bragg angle (2θ±0.2°) for a CuKα characteristic X-ray.

The II-type chlorogallium phthalocyanine crystal of this exemplary embodiment can be suitably produced by the process for producing a gallium phthalocyanine crystal described later.

The particle diameter (median diameter (diameter at the center)) of the II-type chlorogallium phthalocyanine crystal of this exemplary embodiment is preferably from 10 to 300 nm, more preferably from 15 to 250 nm.

Also, GSDᵥ of the II-type chlorogallium phthalo-cyanine crystal of this exemplary embodiment is preferably from 1.0 to 3.0, more preferably from 1.0 to 2.5.

### (V-Type Hydroxygallium Phthalocyanine Crystal)

The V-type hydroxygallium phthalocyanine crystal in an exemplary embodiment of the present invention has a peak in the wavelength range of from about 790 nm to about 809 nm of the spectral absorption spectrum.

Also, in the V-type hydroxygallium phthalocyanine crystal of this exemplary embodiment, the peak of the spectral absorption spectrum is preferably in the wavelength range of from about 791 to about 805 nm.

The V-type hydroxygallium phthalocyanine crystal of this exemplary embodiment is suitable as a charge generating material.

The measurement of the spectral absorption spectrum of the V-type hydroxygallium phthalocyanine crystal in this exemplary embodiment is the same as the measurement of the spectral absorption spectrum of the above-described gallium phthalocyanine crystal.

In the V-type hydroxygallium phthalocyanine crystal of this exemplary embodiment, the peak in the wavelength range of from about 790 nm to about 809 nm is preferably a first or second largest peak, more preferably a second largest peak, in the range of 600 to 900 nm.

When the hydroxygallium phthalocyanine crystal has a V-type crystal form, this can be confirmed by having a diffraction peak at least at 7.5°, 9.9°, 12.5°, 16.3°, 18.6°, 25.1° and 28.3° of the Bragg angle (2θ±0.2°) in the X-ray diffraction spectrum measured using a CuKα characteristic X-ray.

Examples of the raw material of the V-type hydroxygallium phthalocyanine crystal in this exemplary embodiment include I-type hydroxygallium phthalocyanine.

The I-type hydroxygallium phthalocyanine which can be used in this exemplary embodiment is not particularly limited and may be synthesized by a known method, but examples thereof include a method where crude gallium phthalocyanine is produced, for example, by a process of reacting o-phthalodinitrile or 1,3-diiminoisoindoline with gallium trichloride in a predetermined solvent (I-type chlorogallium phthalocyanine process) or a process of heating and reacting o-phthalodinitrile, alkoxygallium and ethylene glycol in a predetermined solvent to synthesize a phthalocyanine dimer (phthalocyanine dimer process) and the obtained crude gallium phthalocyanine is pulverized by an acid pasting treatment and at the same time, converted into I-type hydroxygallium phthalocyanine.

Specifically, the “acid pasting treatment” as used herein means a treatment where the crude gallium phthalo-cyanine dissolved in an acid such as sulfuric acid or formed into an acid salt such as sulfate is poured into an aqueous alkali solution, water or ice water and thereby recrystallized.

The acid for use in the acid pasting treatment is preferably a sulfuric acid, more preferably a sulfuric acid in a concentration of 70 to 100% (still more preferably from 95 to 100%).

The I-type hydroxygallium phthalocyanine synthesized by the method above has a diffraction peak at 6.8 to 7.4°, 13.2 to 14.2°, 16.2 to 16.6°, and 26.5 to 27.5° of the Bragg angle (2θ±0.2°) for a CuKα characteristic X-ray and has an absorption peak in the range of 615 to 635 nm and the range of 850 to 890 nm of the spectral absorption spectrum.

The V-type hydroxygallium phthalocyanine crystal of this exemplary embodiment can be suitably produced by the process for producing a gallium phthalocyanine crystal in an exemplary embodiment of the present invention described later.

The particle diameter (median diameter (diameter at the center)) of the V-type hydroxygallium phthalocyanine crystal of this exemplary embodiment is preferably from 10 to 300 nm, more preferably from 20 to 250 nm.

Also, GSD_{V} of the V-type hydroxygallium phthalo-cyanine crystal of this exemplary embodiment is preferably from 1.0 to 2.8, more preferably from 1.0 to 2.4.

### (Production Process of Gallium Phthalocyanine Crystal)

The process for producing a gallium phthalocyanine crystal in an exemplary embodiment of the present invention includes a solution preparing step of dissolving a gallium phthalocyanine compound in a good solvent to prepare a solution, and a crystal forming step of mixing a bad solvent for the gallium phthalocyanine compound with the solution in a microreactor to obtain a crystal of the gallium phthalocyanine compound.

In the production process of a gallium phthalocyanine crystal of this exemplary embodiment, by virtue of the construction above, a crystal having a small particle diameter and a narrow particle size distribution can be obtained and excellent control of the crystal form can be attained.

The II-type chlorogallium phthalocyanine crystal in the exemplary embodiment of the present invention and the V-type hydroxygallium phthalocyanine crystal in the exemplary embodiment of the present invention are preferably produced by the production process of a gallium phthalocyanine crystal of this exemplary embodiment.

### <Solution Preparing Step>

In the production process of a gallium phthalocyanine crystal of this exemplary embodiment, the solution preparing step is a step of dissolving a gallium phthalocyanine compound in a good solvent to prepare a solution.

The solution obtained by the solution preparing step is preferably a solution where the gallium phthalocyanine compound is well dissolved. By virtue of well dissolution, a gallium phthalocyanine compound crystal having a high crystal form purity can be obtained.

The gallium phthalocyanine compound which can be used in the solution preparing step is not particularly limited and a desired gallium phthalocyanine compound may be used. For example, in the case of producing the II-type chlorogallium phthalocyanine crystal in the exemplary embodiment of the present invention, I-type chlorogallium phthalocyanine is preferred in view of easy synthesis and availability, and in the case of producing a V-type hydroxygallium phthalocyanine crystal in the exemplary embodiment of the present invention, I-type hydroxygallium phthalocyanine is preferred in view of easy synthesis and availability.

The good solvent is a good solvent for the gallium phthalocyanine compound and indicates a solvent allowing high solubility of the gallium phthalocyanine compound. Also, the bad solvent for the gallium phthalocyanine compound, which is described later, indicates a solvent allowing low solubility of the gallium phthalocyanine compound or no dissolution of the gallium phthalocyanine compound.

Specific preferred examples of the good solvent for the gallium phthalocyanine compound include an aprotic polar solvent having a dielectric constant of 30 or more, such as N-methylpyrrolidone, dimethyl sulfoxide, dimethyl-acetamide, dimethylsulfoamide and N,N-dimethylformamide.

One kind of the good solvent may be used alone, or two or more kinds thereof may be used in combination.

As for the mixing ratio between the gallium phthalocyanine compound and the good solvent, the good solvent is preferably from about 20 parts by weight to about 10,000 parts by weight, more preferably from about 30 parts by weight to about 5,000 parts by weight, per 1 part by weight of the gallium phthalocyanine compound. Within this range, the gallium phthalocyanine compound is dissolved in a large amount and excellent productivity is attained.

The liquid viscosity of the solution is preferably 250 mPa·s or less. After the dissolution, the solution is preferably subjected to a filtration or centrifugal separation treatment for removing insoluble matters.

For the production of the solution in the solution preparing step, a known mixing apparatus or a known stirring apparatus can be suitably used.

When producing a solution in the solution preparing step, after mixing the gallium phthalocyanine compound with the good solvent, the insoluble matters or impurities are preferably removed using a known filtration device such as filter and paper filter, or a known centrifugal separation apparatus. Specific examples of the filter include a polytetrafluoroethylene-made membrane filter. The pore size of the filter or paper filter is preferably from 0.10 to 0.50 μm.

It is also preferred to perform heating at the time of mixing the gallium phthalocyanine compound and the good solvent. Furthermore, if desired, a microreactor in the crystal forming step may be introduced while heating the solution. At this time, the liquid temperature is preferably maintained also in the microreactor.

The gallium phthalocyanine compound which can be used in the solution preparing step is preferably produced using a microreactor. As for the microreactor, a microreactor described later in regard to the crystal forming step can be suitably used.

In the conventional process of producing a pigment or a pigment liquid dispersion, a drying step and a dispersing (or grinding) step are performed repeatedly. However, in the case of using a microreactor, these steps need not be repeated.

For example, when a microreactor is used in the granulating step using acid pasting and when the solution is passed through a micromixer having provided therein an ion-exchange membrane or filter for washing and removing a salt such as ammonium sulfate produced as a reaction by-product, a high-purity gallium phthalocyanine compound is very efficiently produced.

In order to increase the pigment concentration and continuously perform the crystal forming step, the solvent displacement is preferably performed using a microreactor.

After the completion of the crystal forming step, the solvent displacement and washing are preferably performed at the same time by using a different solvent, and use of a microreactor for the washing is more preferred.

It is also possible that without performing a drying step after washing, the solvent displacement to a solvent for the production of a coating solution for producing a photoreceptor is performed and the solution is mixed with a solution having dissolved therein a resin and adjusted to a predetermined pigment concentration, and use of a microreactor for the solvent displacement is more preferred.

When this series of steps are continuously performed using a microreactor, aggregation of the pigment in the drying step is suppressed and a liquid dispersion having a narrow particle size distribution and a small particle diameter is obtained.

Also, in the washing step, when the pigment is passed through a microchannel with the half of the channel being composed of an ion-exchange membrane or a filter having micropores, the pigment flows on the outer side of the channel and the liquid containing impurities is discharged out of the system from the ion-exchange membrane or filter on the inner side, whereby the washing efficiency is enhanced and deterioration of the ion-exchange membrane or clogging of the filter is reduced.

In the production of the gallium phthalocyanine compound particle, when a static mixer is used in the granulating process (acid pasting) of dissolving the pigment in a solvent such as sulfuric acid and charging the solution into water or an alkaline aqueous solution to form particles, the particle can be formed with good efficiency.

Specific preferred examples of the method therefor include a method of disposing one or a plurality of helically twisted plates in the cylindrical channel. Furthermore, the pigment in the form of a sulfuric acid solution and the water or alkaline aqueous solution are preferably once rotated and then inversely rotated by disposing the helically twisted plate and inverting the twisting direction in midway. This exemplary embodiment favors an increase in the action of mixing with stirring.

The number of plates helically disposed is preferably from 1 to 8, more preferably from 2 to 4. The length in the protruding direction of the helical plate is preferably from 30 to 90%, more preferably from 50 to 80%, of the radius of the cylindrical channel, because appropriate mixing can be performed by generating a sufficiently high rotational power. The helical pitch is not particularly limited and is varied according to the purpose.

### (Crystal Forming Step)

In the production process of a gallium phthalocyanine crystal of this exemplary embodiment, the crystal forming step is a step of mixing a bad solvent for the gallium phthalocyanine compound with the solution in a microreactor to obtain a crystal of the gallium phthalocyanine compound.

The bad solvent for the gallium phthalocyanine compound is a solvent allowing low solubility of the gallium phthalocyanine compound or a solvent not allowing dissolution of the gallium phthalocyanine compound.

Specific preferred examples of the bad solvent for the gallium phthalocyanine compound include, in addition to a nonpolar solvent such as hexane, benzene and toluene, water, acetone, methyl ethyl ketone and methyl isobutyl ketone. Among these, water is more preferred. In particular, the water is preferably ion-exchanged water.

One kind of the bad solvent may be used alone, or two or more kinds thereof may be used in combination.

In the crystal forming step, the solution obtained in the solution preparing step and the bad solvent are mixed in a microreactor to obtain a crystal of the phthalocyanine compound.

The microreactor for use in this exemplary embodiment is a small three-dimensional structure used for performing a chemical reaction. The microreactor is sometimes called a microchannel reactor, and the microreactor for the purpose of mixing is sometimes called a micromixer.

Such a reaction apparatus is recently attracting attention and is described in detail, for example, in Wolfgang Ehrfeld, Volker Hessel and Holger Loewe, Microreactors New Technology for Modern Chemistry, WILEY-VCH (2000).

In the crystal forming step, for example, the following microreactor may be suitably used.

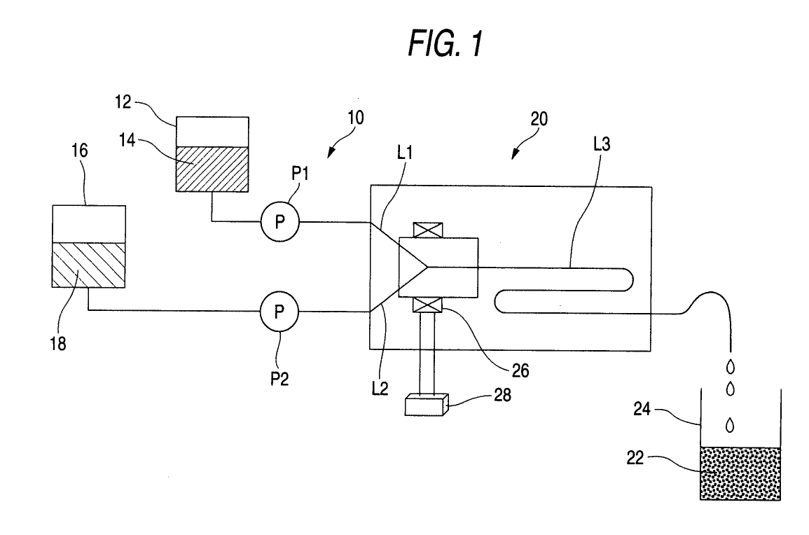

FIG. 1 is a schematic construction view showing one example of the apparatus having a microreactor suitably used for the production process of a gallium phthalocyanine crystal of this exemplary embodiment.

The apparatus 10 shown in FIG. 1 includes two tanks 12 and 16, a microreactor 20, liquid feed pumps P1 and P2, a vessel 24, and channels connecting these.

The tank 12 contains, as a first fluid 14, a solution prepared by dissolving a gallium phthalocyanine compound in a good solvent, and the tank 16 contains, as a second fluid 18, a bad solvent for the gallium phthalocyanine compound.

The first fluid 14 in the tank 12 and the second fluid 18 in the tank 16 are extruded into the channels L1 and L2 by the liquid feed pumps P1 and P2, respectively, fed to the microreactor 20 and joined together in the channel L3. In the channel L3, crystallization of the gallium phthalocyanine compound proceeds, and a mixed solution 22 containing a gallium phthalocyanine crystal is obtained. The mixed solution 22 is recovered in the vessel 24.

In the microreactor 20, a heater 26 is disposed, and the temperature thereof is adjusted by a temperature control unit 28. As for the heater, metal resistance, polysilicon or the like may be used, and the heater 26 may be built in the unit. If desired, the heater 26 may be another heating unit or may also be a cooling unit or a temperature adjusting unit. Furthermore, for controlling the temperature, the apparatus 10 as a whole or the microreactor 20 as a whole may be placed in a temperature-controlled vessel.

The channels L1, L2 and L3 of the microreactor 20 are microscale.

Such a microreactor 20 can be produced on a solid substrate suitably by a microfabrication technique.

The microfabrication technique is not particularly limited, but examples thereof include a LIGA technique using X-ray, a method using a resist part as a structure by photolithography, a method of further etching an opening in the resist, a microdisharge machining method, a laser machining method, and a mechanical microcutting method using a microtool formed of a hard material such as diamond. One of these techniques may be used alone, or some of these may be used in combination.

The temperature of the first fluid 14 at the junction of L1 and L2 in the microreactor 20 is preferably 30° C. or more, more preferably 35° C. or more, still more preferably 40° C. or more. The temperature of the second fluid 18 at the junction of L1 and L2 is preferably 30° C. or less, more preferably 20° C. of less. As for the temperature of the fluid in L3 of the microreactor 20, the preferred temperature range is the same as that of the second fluid.

Incidentally, the temperature of each fluid is adjusted to a temperature not causing solidification of the solution.

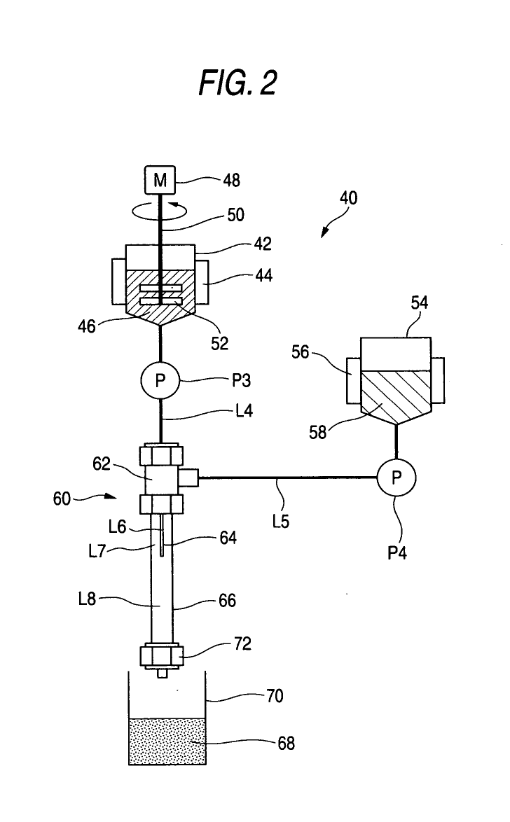

FIG. 2 is a schematic construction view showing one example of the apparatus having a double-tube microreactor suitably used for the production process of a gallium phthalocyanine crystal of this exemplary embodiment.

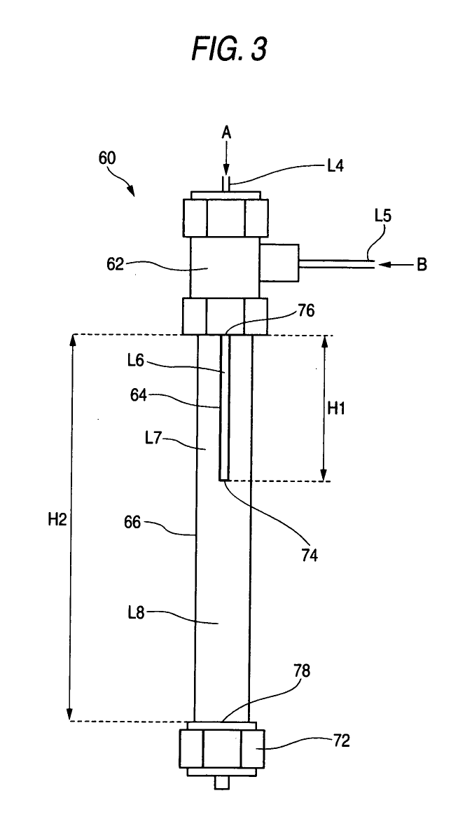

FIG. 3 is an enlarged schematic view of the double-tube microreactor used in FIG. 2.

The apparatus 40 shown in FIG. 2 includes two tanks 42 and 54, a double-tube microreactor 60, liquid feed pumps P3 and P4, a vessel 70, and channels connecting these.

The tank 42 equipped with a jacket 44 for temperature control contains, as a first fluid 46, a solution prepared by dissolving a gallium phthalocyanine compound in a good solvent, and the tank 54 equipped with a jacket 58 for temperature control contains, as a second fluid 58, a bad solvent for the gallium phthalocyanine compound. Furthermore, the tank 42 has a stirring device composed of a rotation drive mechanism 48, a rotating shaft 50 and a plurality of stirring blades 52 fixed to the rotating shaft 50. This stirring device may be equipped in each tank, if-desired.

The first fluid 46 in the tank 42 and the second fluid 58 in the tank 54 are extruded into the channels L4 and L5 by the liquid feed pumps P3 and P4, respectively, and fed to the microreactor 60. The first fluid 46 and second fluid 58 fed from the channels L4 and L5 are fed to channels L6 and L7, respectively, through a connection part 62. The first channel forming member 64 forms the channel L6, and a second channel forming member 66 on the outer periphery thereof forms the channel L7 having a doughnut-like cross-sectional shape. The first fluid 46 fed through the channel L6 and the second fluid 58 fed through the channel L7 are joined together in the channel L8 having a circular cross-section located downstream of the end 74 of the channel L6. In the channel L8, crystallization of the gallium phthalocyanine compound proceeds, and a mixed solution 68 containing a gallium phthalocyanine crystal is obtained. The mixed solution 68 passes through a valve 72 for adjusting the discharge velocity and is recovered in the vessel 70.

The outflow velocity from the double-tube micro-reactor sometimes increases above the preset velocity by the effect of gravity to make it difficult to form a laminar flow in the channel and therefore, as shown in FIG. 2, a valve 72 for adjusting the discharge velocity is fixed to the end 78 of the channel L8 in the double-tube microreactor 60, whereby a laminar flow can be formed. By virtue of providing the valve 72 for adjusting the discharge velocity, a laminar flow can be easily formed even when the flow velocity is increased, and this is suitable for high-speed and/or massive processing.

The internal diameter and external diameter of the first channel forming member 64 and the internal diameter of the second channel forming member 66, that is, the diameters of the channels L6, L7 and L8, each may be sufficient if it is microscale (2,000 μm or less), and the channel diameter may be appropriately selected as needed.

The length H1 from the end 76 of the connection part to the end 74 of the channel L6 and the length H2 from the end 76 of the connection part to the end 78 of the channel L8 each may be appropriately selected by taking into consideration the progress of crystallization of the gallium phthalocyanine compound.

Other than the microreactors shown in FIGS. 1, 2 and 3, preferred examples of the microreactor which can be used in the crystal forming step include microreactors described in JP-A-2005-288254 and JP-A-2006-342304, micromixers disclosed in JP-T-9-512742 (the term “JP-T” as used herein means a “published Japanese translation of a PCT patent application”) and International Publication No. 00/76648, pamphlet, and those commercially available from IMM (Institut fuer Mikrotechnik Mainz GmbH and Forschungs-zentrum Karlsruhe of Germany.

The diameter or long side (channel size) of the channel in the microreactor may be sufficient if it is microscale, and in each channel, the diameter or long side is 2,000 μm or less, preferably from 10 to 1,000 μm, more preferably from 30 to 500 μm. Incidentally, when the cross-section of the channel is not circular, square or rectangular, the channel diameter is defined as an equivalent-circle size (diameter) determined from the cross-sectional area of the channel cut by the surface perpendicular to the flow direction.

The depth of the channel is preferably from 10 to 500 μm.

The length of the channel may be appropriately selected by taking into consideration the progress of crystallization of the gallium phthalocyanine compound.

The shape of the channel is not particularly limited and, for example, the cross-sectional shape in the direction perpendicular to the flow direction may be a desired shape such as circle, ellipsoid, polygon (including rectangle), doughnut or barrel.

The liquid feed velocity of each of the solution and the bad solvent is not particularly limited, and a velocity not causing any trouble in the crystallization of the gallium phthalocyanine may be appropriately selected according to the channel size, concentration of solution, temperature in channel, or the like.

The liquid feed velocity V₁ of the solution and the liquid feed velocity V₂ of the bad solvent preferably satisfy the condition represented by the following formula (1):

1≦(V₂/V₁)≦20 (1)

When V₂/V₁ is in the range above, crystallization of the gallium phthalocyanine compound proceeds successfully and continuously.

The material of the microreactor may be any material as long as it causes no problem during feeding of a fluid such as the above-described solution or bad solvent and during crystallization of the gallium phthalocyanine compound, and examples of the material include metal, ceramic, glass, fused silica, silicone and synthetic resin. A synthetic resin having solvent resistance, or a synthetic resin subjected to a solvent resistance treatment may also be used.

Among these, glass, fused silica and synthetic resin are preferred. In view of excellent heat resistance and chemical resistance, glass and fused silica are more preferred, and in view of processability, synthetic resin is more preferred.

From the aspect of impact resistance, heat resistance, chemical resistance, transparency and the like, specific preferred examples of the synthetic resin which can be used as the material of the microreactor include polyester resin, styrene resin, acrylic resin, styrene•acrylic resin, silicone resin, epoxy resin, diene-based resin, phenol resin, terpene resin, coumarin resin, amide resin, amideimide resin, butyral resin, urethane resin, and ethylene•vinyl acetate resin, with epoxy resin being more preferred.

Also, as for the thermosetting resin, heat curable resin and thermoplastic resin, those described in Kobunshi Dai-Jiten (Comprehensive Dictionary of Polymers), Maruzene (1994) may also be suitably used, if desired.

The size of the microreactor may be appropriately set according to the intended use.

The microreactor may have a site having a function such as separation, purification, analysis and washing, according to usage.

Also, in the microreactor, for example, a liquid feed port for feeding a liquid to each channel, and a recovery port for recovering a liquid from the microreactor are preferably provided, if desired.

Furthermore, an apparatus or system suitably usable for the production process of a gallium phthalocyanine crystal of this exemplary embodiment may be constructed by combining, according to usage, a plurality of microreactors or combining the microreactor with a unit having a function such as separation, purification, analysis or washing, a liquid feed unit, a recovery unit, another microchannel device, or the like.

### (Photoreceptor)

The photoreceptor in an exemplary embodiment of the present invention has a functional layer containing a gallium phthalocyanine crystal such as II-type chlorogallium phthalocyanine crystal in the exemplary embodiment of the present invention or V-type hydroxygallium phthalocyanine crystal in the exemplary embodiment of the present invention.

Hereinafter, “the II-type chlorogallium phthalo-cyanine crystal in the exemplary embodiment of the present invention and/or the V-type hydroxygallium phthalocyanine crystal in the exemplary embodiment of the present invention” are sometimes referred to as “the gallium phthalocyanine crystal in the exemplary embodiment of the present invention”.

The photoreceptor of this exemplary embodiment preferably contains the gallium phthalocyanine crystal in the exemplary embodiment of the present invention as a charge generating material in the functional layer.

The photoreceptor of this exemplary embodiment can be suitably used as an electrophotographic photoreceptor.

The functional layer in the photoreceptor of this exemplary embodiment may be composed of one layer or two or more layers and is preferably a photosensitive layer.

The photosensitive layer may be composed of one layer or two or more layers and is preferably a layer obtained by stacking a charge generating layer and a charge transport layer, more preferably a layer obtained by stacking a charge generating layer containing the II-type chloro-gallium phthalocyanine crystal in the exemplary embodiment of the present invention or the V-type hydroxygallium phthalocyanine crystal in the exemplary embodiment of the present invention, and a charge transport layer.

### <Layer Construction of Photoreceptor>

The photoreceptor of this exemplary embodiment has at least a photosensitive layer on an electrically conductive substrate. Here, “on” an electrically conductive substrate is sufficient if the photosensitive layer is located on the upper side of the electrically conductive substrate. That is, the photosensitive layer need not be provided in contact with the electrically conductive substrate. The photosensitive layer may be provided in contact with the electrically conductive substrate, or other layers may be provided between the electrically conductive substrate and the photosensitive layer.

The photosensitive layer in the photoreceptor of this exemplary embodiment preferably contains the gallium phthalocyanine crystal in the exemplary embodiment of the present invention as a charge generating material.

Preferred exemplary embodiments are described below by referring to the drawings, but the layer construction of the photoreceptor of this exemplary embodiment is not limited thereto. In the drawings, the same or corresponding portion is denoted by the same reference numeral or sign, and redundant description is omitted.

### (1) First Exemplary Embodiment

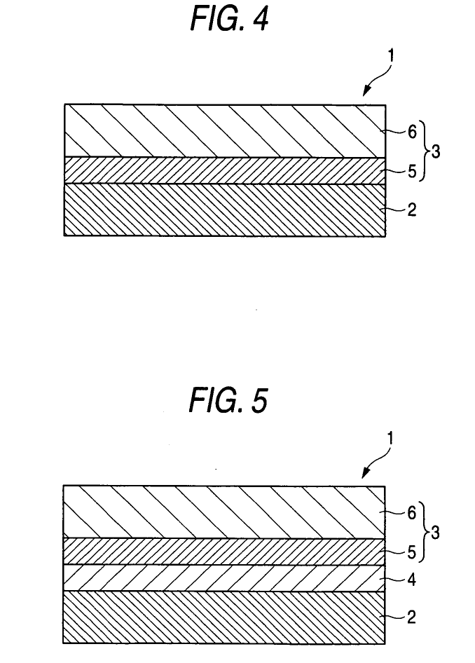

FIG. 4 is a cross-sectional view showing a first exemplary embodiment of the photoreceptor of this exemplary embodiment.

As shown in FIG. 4, the photoreceptor 1 is composed of an electrically conductive substrate 2, a photosensitive layer 3, and a charge generating layer 5 and a charge transport layer 6 constituting the photosensitive layer 3.

### (2) Second Exemplary Embodiment

FIG. 5 is a cross-sectional view showing a second exemplary embodiment of the photoreceptor of this exemplary embodiment.

As shown in FIG. 5, the photoreceptor 1 is composed of an electrically conductive substrate 2, a subbing layer 4, a photosensitive layer 3, and a charge generating layer 5 and a charge transport layer 6 constituting the photosensitive layer 3. The subbing layer 4 is a layer containing at least a metal oxide particle and a binder.

### (3) Third Exemplary Embodiment

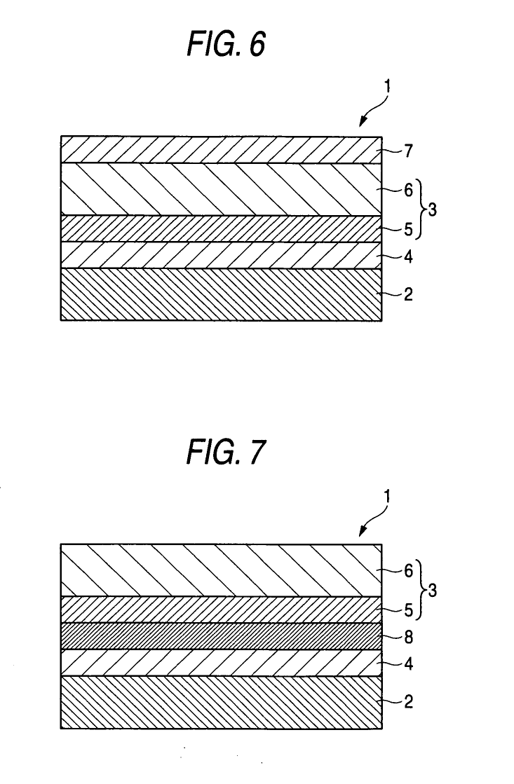

FIG. 6 is a cross-sectional view showing a third exemplary embodiment of the photoreceptor of this exemplary embodiment.

The photoreceptor 1 shown in FIG. 6 has the same construction as that of the photoreceptor 1 shown in FIG. 5 except that a protective layer 7 is provided on the photosensitive layer 3. The protective layer 7 is used for preventing a chemical change of the charge transport layer 6 at the electrical charging of the photoreceptor 1 or more improving the mechanical strength of the photo sensitive layer 3. The protective layer 7 can be formed by incorporating an electrically conductive material into an appropriate binder to prepare a coating solution and applying the coating solution on the photosensitive layer 3.

### (4) Fourth Exemplary Embodiment

FIG. 7 is a cross-sectional view showing a fourth exemplary embodiment of the photoreceptor of this exemplary embodiment.

The photoreceptor 1 shown in FIG. 7 has the same construction as that of the photoreceptor 1 shown in FIG. 5 except that an intermediate layer 8 is provided between the photosensitive layer 3 and the subbing layer 4. The intermediate layer 8 is provided for enhancing the electric characteristics of the photoreceptor 1, enhancing the image quality, and enhancing the adhesion of the photosensitive layer 3. The constituent material of the intermediate layer 8 is not particularly limited and may be arbitrarily selected from synthetic resin, organic or inorganic substance powder, electron transport substance and the like.

In the photoreceptor of this exemplary embodiment, when the photosensitive layer is composed of two layers (charge generating layer and charge transport layer), the thickness of the layer disposed on the upper side than the charge generating layer for obtaining high resolution is preferably 50 μm or less, more preferably 40 μm or less. In the case where the charge transport layer is a thin film having a thickness of 20 μm or less, a photoreceptor constructed such that a high-strength protective layer similar to the subbing layer is disposed on the charge transport layer is particularly effective.

### <Photosensitive Layer (Charge Generating Layer)>

The charge generating layer constituting the photosensitive layer is formed by dispersing the gallium phthalocyanine crystal in the exemplary embodiment of the present invention, which is a charge generating material, together with an organic solvent and a binder, and coating the dispersion obtained (hereinafter sometimes referred to as “dispersion-coating”). In the case of forming the charge generating layer by dispersion-coating, the charge generating material is dispersed together with an organic solvent, a binder, additives and the like and the obtained liquid dispersion is coated, whereby the charge generating layer is formed.

### (1) Charge Generating Material

As for the charge generating material for use in the charge generating layer in the photoreceptor of this exemplary embodiment, at least the gallium phthalocyanine crystal in the exemplary embodiment of the present invention is used. The charge generating material is preferably only the gallium phthalocyanine crystal in the exemplary embodiment of the present invention

Examples of the charge generating material which can be used in combination in the photoreceptor of this exemplary embodiment other than the gallium phthalocyanine crystal in the exemplary embodiment of the present invention include a phthalocyanine pigment except for the gallium phthalocyanine crystal in the exemplary embodiment of the present invention, an azo pigment such as chlorodian blue, a quinone pigment such as anthanthrone bromide and pyrenequinone, a quinocyanine pigment, a perylene pigment, an indigo pigment, a bisbenzimidazole pigment, a pyrrolopyrrole pigment, an azulenium salt, squarylium and quinacridone.

### (2) Binder

Examples of the binder (binder resin, binding resin) which can be used in the charge generating layer include polycarbonate, polystyrene, polysulfone, polyester, polyimide, polyester carbonate, polyvinyl butyral, a methacrylic acid ester copolymer, a vinyl acetate homopolymer or copolymer, cellulose ester, cellulose ether, polybutadiene, polyurethane, phenoxy resin, epoxy resin, silicone resin, fluororesin, and a partially crosslinked cured product thereof.

One of these binders which can be used in the charge generating layer may be used alone, or two or more kinds thereof may be used in combination.

### (3) Solvent

The solvent which can be used at the production of the charge generating layer is preferably a solvent in which the gallium phthalocyanine crystal in the exemplary embodiment of the present invention has low solubility. Specific examples thereof include methanol, ethanol, n-butanol, acetone, methyl ethyl ketone, cyclohexanone, methyl acetate, n-butyl acetate, dioxane, toluene, xylene and water. One of these solvents may be used alone, or a mixture of two or more kinds thereof may be used.

### (4) Blending Amount

The concentration of solid contents in the binder solution is preferably from 0.1 to 10 wt %, more preferably from 1.0 to 7.0 wt %. Within this range, good sensitivity is obtained by virtue of the appropriate amount of the charge generating material in the liquid dispersion and also, the productivity at the coating of the photoreceptor is high because of appropriate viscosity of the liquid dispersion.

The concentration of the solid contents in the mixed solution of the charge generating material and the solvent is preferably from 0.1 to 20 wt %, more preferably from 1 to 15 wt %. Within this range, the adhesion or contact of the film coating is good and a charge generating layer excellent in the sensitivity or cycle stability is obtained.

The charge generating material and solvent are preferably subjected to a dispersion treatment in advance. In this case, examples of the method for performing the dispersion treatment include sand mill, colloid mill, attritor, ball mill, Dyno mill, high-pressure homogenizer, ultrasonic disperser, co-ball mill and roll mill.

### (5) Coating Method

As for the coating method used in providing the charge generating layer, an ordinary method such as blade coating, wire bar coating, spray coating, dip coating, bead coating, air knife coating and curtain coating may be used. After coating the charge generating layer, the solvent in the film is removed through drying in a dryer or by natural drying. The drying temperature and time can be arbitrarily set.

### (6) Additive

For the purpose of preventing the photoreceptor from deterioration due to zone or oxidative gas generated in the image forming apparatus or due to light and heat, additives such as antioxidant, photostabilizer and/or thermal stabilizer may be added to the photosensitive layer of the photoreceptor of this exemplary embodiment.

Examples of the antioxidant include hindered phenol, hindered amine, para-phenylenediamine, arylalkane, hydro-quinone, spirochroman, spiroindanone, derivatives thereof, an organosulfur compound and an organophosphorus compound.

Specific examples thereof include methylphenol, styrenated phenol, n-octadecyl-3-(3′,5′-di-tert-butyl-4′-hydroxyphenyl)propionate, 2,2′-methylene-bis(4-methyl-6-tert-butylphenol), 2-tert-butyl-6-(3′-tert-butyl-5′-methyl-2′-hydroxybenzyl)-4-methylphenyl acrylate, 4,4′-butylidene-bis(3-methyl-6-tert-butylphenol), 4,4′-thio-bis-(3-methyl-6-tert-butylphenol), 1,3,5-tris(4-tert-butyl-3-hydroxy-2,6-dimethylbenzyl)isocyanurate, tetrakis[methylene-3-(3′,5′-di-tert-butyl-4′-hydroxyphenyl)propionate]methane, and 3,9-bis{2-[3-(3-tert-butyl-4-hydroxy-5-methylphenyl)propionyl-oxy]-1,1-dimethylethyl]-2,4,8,10-tetraoxaspiro[5,5]undecane.

Examples of the hindered amine-based compound include bis(2,2,6,6-tetramethyl-4-piperidyl)sebacate, bis-(1,2,2,6,6-pentamethyl-4-piperidyl)sebacate, 1-{2-[3-(3,5-di-tert-butyl-4-hydroxyphenyl)propionyloxy]ethyl}-4-[3-(3,5-di-tert-butyl-4-hydroxyphenyl)propionyloxy]-2,2,6,6-tetramethylpiperidine, 8-benzyl-7,7,9,9-tetramethyl-3-octyl-1,3,8-triazaspiro[4,5]-undecane-2,4-dione, 4-benzoyl-oxy-2,2,6,6-tetramethylpiperidine, a dimethyl succinate-1-(2-hydroxyethyl)-4-hydroxy-2,2,6,6-tetramethylpiperizine polycondensate, poly-[{6-(1,1,3,3-tetramethylbutyl)imino-1,3,5-triazine-2,4-diimyl}{(2,2,6,6-tetramethyl-4-piperidyl)imino}hexamethylene{(2,3,6,6-tetramethyl-4-piperidyl)imino}], 2-(3,5-di-tert-butyl-4-hydroxybenzyl)-2-n-butylmalonic acid bis(1,2,2,6,6-pentamethyl-4-piperidyl), and an N,N′-bis-(3-aminopropyl)ethylenediamine-2,4-bis[N-butyl-N-(1,2,2,6,6-pentamethyl-4-piperidyl)amino]-6-chloro-1,3,5-triazine condensate.

Examples of the organosulfur-based antioxidant include dilauryl-3,3′-thiodipropionate, dimyristyl-3,3′-thiodipropionate, distearyl-3,3′-thiodipropionate, penta-erythritol-tetrakis(β-lauryl-thiopropionate), ditridecyl-3,3′-thiodipropionate, and 2-mercaptobenzimidazole.

Examples of the organophosphorus-based antioxidant include trisnonylphenyl phosphite, triphenyl phosphite, and tris(2,4-di-tert-butylphenyl)phosphite.

The organosulfur-based and organophosphorus-based antioxidants are called a secondary antioxidant and when used in combination with a primary antioxidant such as phenol-based or amine-based antioxidant, a synergistic effect can be obtained.

The photostabilizer includes benzophenone-based, benzotriazole-based, dithiocarbamate-based and tetramethyl-piperidine-based derivatives.

Examples of the benzophenone-based photostabilizer include 2-hydroxy-4-methoxybenzophenone, 2-hydroxy-4-octoxybenzophenone, and 2,2′-dihydroxy-4-methoxy-benzophenone.

Examples of the benzotriazole-based photostabilizer include 2-(2′-hydroxy-5′-methylphenyl)-benzotriazole, 2-[2′-hydroxy-3′-(3″,4″,5″,6″-tetrahydrophthalimidomethyl)-5′-methylphenyl]-benzotriazole, 2-(2′-hydroxy-3′-tert-butyl-5′-methylphenyl)-5-chlorobenzotriazole, 2-(2′-hydroxy-3′-tert-butyl-5′-methylphenyl)-5-chlorobenzotri-azole, 2-(2′-hydroxy-3′,5′-tert-butylphenyl)benzotriazole, 2-(2′-hydroxy-5′-tert-octylphenyl)benzotriazole, and 2-(2′-hydroxy-3′,5′-di-tert-amylphenyl)benzotriazole.

Examples of other compounds include 2,4-di-tert-butylphenyl-3′,5′-di-tert-butyl-4′-hydroxybenzoate and nickel dibutyl dithiocarbamate.

Also, the photosensitive layer may contain at least one kind of an electron accepting substance for the purposes of enhancing the sensitivity, decreasing the residual potential, reducing the fatigue on repeated use, and the like.

Examples of the electron accepting substance which can be used in this exemplary embodiment include succinic anhydride, maleic anhydride, dibromomaleic anhydride, phthalic anhydride, tetrabromophthalic anhydride, tetra-cyanoethylene, tetracyanoquinodimethane, o-dinitrobenzene, m-dinitrobenzene, chloranil, dinitroanthraquinone, trinitrofluorenone, picric acid, o-nitrobenzoic acid, p-nitrobenzoic acid, and phthalic acid. Among these, a fluorenone-based or quinone-based compound and a benzene derivative containing an electron-withdrawing group such as —Cl, —CN and —NO₂ are preferred. Furthermore, in the coating solution for the formation of photosensitive layer, a small amount of a silicone oil may also be added as a leveling agent for enhancing the flatness of the film coating.

### <Photosensitive Layer (Charge Transport Layer)>

The charge transport layer includes a charge transport material and a binder.

### (1) Charge Transport Material

The charge transport layer in the photoreceptor of this exemplary embodiment contains a charge transport material.

The charge transport material contained in the charge transport layer is not particularly limited, and a known substance can be used.

Examples thereof include a hole transport substance such as oxadiazole derivative (e.g., 2,5-bis(p-diethyl-aminophenyl)-1,3,4-oxadiazole), pyrazoline derivative (e.g., 1,3,5-triphenyl-pyrazoline, 1-[pyridyl-(2)]-3-(p-diethyl-aminostyryl)-5-(p-diethylaminostyryl)pyrazoline), aromatic tertiary amino compound (e.g., triphenylamine, tri(p-methyl)phenylamine, N,N′-bis(3,4-dimethylphenyl)biphenyl-4-amine, dibenzylaniline, 9,9-dimethyl-N,N′-di(p-nitrile)-fluorenon-2-amine), triformylphenylamine aromatic tertiary diamino compound (e.g., N,N′-diphenyl-N,N′-bis(3-methylphenyl)-(1,1-biphenyl)-4,4′-diamine), 1,2,4-triazine derivative (e.g., 3-(4′-dimethylaminophenyl)-5,6-di-(4′-methoxyphenyl)-1,2,4-triazine), hydrazone derivative (e.g., 4-diethylaminobenzaldehyde-1,1-diphenylhydrazone, 4-diphenylaminobenzaldehyde-1,1-diphenylhydrazone, [p-(diethylamino)phenyl](1-naphthyl)phenylhydrazone), quinazoline derivative (e.g., 2-phenyl-4-styryl-quinazoline), benzofuran derivative (e.g., 6-hydroxy-2,3-di(p-methoxyphenyl)benzofuran), α-stilbene derivative (e.g., p-(2,2-diphenylvinyl)-N,N′-diphenylaniline), enamine derivative, carbazole derivative (e.g., N-ethylcarbazole), and poly-N-vinylcarbazole or derivative thereof; and an electron transport substance such as quinone-based compound (e.g., chloranil, bromanil, anthraquinone), tetracyanoquinodimethane-based compound, fluorenone-based compound (e.g., 2,4,7-trinitrofluorenone, 2,4,5,7-tetranitro-9-fluorenone), oxadiazole-based compound (e.g., 2-(4-biphenyl)-5-(4-tert-butylphenyl)-1,3,4-oxadiazole, 2,5-bis(4-naphthyl)-1,3,4-oxadiazole, 2,5-bis(4-diethylaminophenyl)-1,3,4-oxadiazole), xanthone-based compound, thiophene-based compound, and diphenoquinone-based compound (e.g., 3,3′,5,5′-tetra-tert-butyldipheno-quinone. Furthermore, examples of the charge transport material include a polymer having the basic structure of the above-described compound in the main or side chain.

One of these charge transport materials may be used alone, or two or more kinds thereof may be used in combination.

The charge transport material may be a commercially available compound or may be synthesized.

In the case of synthesizing the charge transport material, the charge transport material is preferably synthesized using a microreactor. Preferred examples of the microreactor include those described above.

Examples of the synthesis using a microreactor include synthesis of triformyltriphenylamine.

Conventionally, in the case where triformylation is performed using phosphorus oxychloride and dimethyl-formamide in the synthesis of a charge transport material using triphenylamine, since a mixture of di-form and tri-form is produced, the yield of the objective triformyl-triphenylamine is low and the purity is low as about 70%. However, when a microreactor is used at the time of this reaction, the yield rises.

Specifically, a 1:1 mixture of dimethylformamide and phosphorus oxychloride is reacted with 5-fold equivalent or more of the reaction site with respect to triphenylamine. At this time, the yield of the objective triformyl form is increased to 80% or more by using a micromixer or a micro-reactor.

### (2) Binder

The binder contained in the charge transport layer is not particularly limited and a known binder may be used, but a resin capable of forming an electrically insulating film is preferred. Examples thereof include polycarbonate resin, polyester resin, methacrylic resin, acrylic resin, polyvinyl chloride resin, polyvinylidene chloride resin, polystyrene resin, polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, silicone resin, silicone-alkyd resin, phenol-formaldehyde resin, styrene-alkyd resin, poly-N-carbazole, polyvinyl butyral, polyvinyl formal, polysulfone, casein, gelatin, polyvinyl alcohol, ethyl cellulose, phenol resin, polyamide, carboxy-methyl cellulose, a vinylidene chloride-based polymer wax, and polyurethane. One of these binder resins may be used alone, or two or more kinds thereof may be mixed and used. Above all, polycarbonate resin, polyester resin, methacrylic resin and acrylic resin are preferred because these are excellent in terms of compatibility with the charge transport material, solubility in the solvent, and strength.

### (3) Blending Ratio

The blending ratio (weight ratio) between the binder and the charge transport material may be arbitrarily set by taking into consideration the deterioration of electric characteristics and reduction of the film strength. The thickness of the charge transport layer is preferably from 5 to 50 μm, more preferably from 10 to 40 μm.

### (4) Production Method

The charge transport layer can be formed by preparing mixing a charge transport material, an organic solvent, a binder and the like to prepare a coating solution, applying the coating solution onto the charge generating layer, and drying the film coating.

In preparing a coating solution for the formation of charge transport layer, a charge transport material is mixed together with an organic solvent, a binder and the like. As for the method of highly dispersing the charge transport material in a liquid, a dispersion method such as roll mill, ball mill, vibration ball mill, attritor, sand mill, colloid mill and paint shaker can be used.

Furthermore, in view of film-forming property, the particle diameter of the particle contained in the coating solution for forming the charge transport layer is preferably 0.5 μm or less, more preferably 0.3 μm or less, still more preferably 0.15 μm. When the particle diameter of the particle is 0.5 μm or less, the film-forming property of the charge transport layer is excellent and an image quality defect is less generated.

As regards the solvent used in the coating solution for forming the charge transport layer, one of ordinary organic solvents such as dioxane, tetrahydrofuran, methylene chloride, chloroform, chlorobenzene and toluene may be used alone, or two or more kinds thereof may be mixed and used.

As for the coating method of the charge transport layer, an ordinary method such as blade coating, wire bar coating, spray coating, dip coating, bead coating, air knife coating and curtain coating may be used.

Also, the coating method used for providing the charge transport layer is preferably a method using a dip coating apparatus in which a coating solution prepared by at least dispersing a charge transport material is circulated and which is equipped with a micromixer or microreactor midway in the circulation system circulating the coating solution.

### <Photosensitive Layer (Single Layer Type)>

The photosensitive layer composed of a single layer is a layer containing substances together including a charge generating material and a charge transport material contained in the charge generating layer and the charge transport layer, respectively. In the case of this single layer-type photosensitive layer, the content of the charge generating material is preferably from 0.1 to 50 wt %, more preferably from 1 to 20 wt %, based on the entire weight of the photosensitive layer. Within this range, appropriate sensitivity is obtained and troubles such as reduction of electric chargeability are not generated.

Also, in the case of the single layer-type photosensitive layer, from the standpoint of compatibility with the hole transport substance, the binder is preferably polycarbonate resin or methacrylic resin. The binder resin may also be selected from organic photoelectrically conductive materials such as poly-N-vinylcarbazole, polyvinylanthracene, polyvinylpyrene and polysilane. One of these binder resins may be used alone, or two or more kinds thereof may be mixed and used. This photosensitive layer can also be formed by mixing the above-described charge generating material, the above-described charge transport material, the above-described organic solvent, the binder resin and the like to prepare a coating solution, applying the coating solution onto an electrically conductive substrate by the same method as above, and drying the film coating.

As for the coating method of the single layer-type photosensitive layer, an ordinary method such as blade coating, wire bar coating, spray coating, dip coating, bead coating, air knife coating and curtain coating may be used.

### <Electrically Conductive Substrate>

The electrically conductive substrate is not particularly limited as long as it has electrical conductivity, and, for example, a metal drum, metal sheet or metal plate formed of aluminum, copper, iron, zinc or nickel may be used. Also, a drum-like, sheet-like or plate-like substrate electroconduction-treated by vapor-depositing a metal such as aluminum, copper, gold, silver, platinum, palladium, titanium, nickel-chrome, stainless steel or copper-indium on polymer-made sheet, paper, plastic or glass may be used. Furthermore, a drum-like, sheet-like or plate-like substrate electroconduction-treated by vapor-depositing an electrically conductive metal compound such as indium oxide or laminating a metal foil on polymer-made sheet, paper, plastic or glass may also be used. Other than these, for example, a drum-like, sheet-like, plate-like substrate electroconduction-treated by dispersing carbon black, indium oxide, tin oxide-antimony oxide powder, metal powder, copper iodide or the like in a binder, and coating the binder on polymer-made sheet, paper, plastic or glass may also be used.

In the case of using a metal pipe as the electrically conductive substrate, the surface thereof may be untreated but is preferably treated in advance by mirror polishing, etching, anodization, rough machining, centerless grinding, sandblasting, wet honing or coloration. By applying a surface treatment to roughen the substrate surface, the woodgrain-like density irregularity which may be generated in the photoreceptor when using a coherent light such as laser beam can be prevented.

### <Subbing Layer>

The photoreceptor of this exemplary embodiment preferably has a subbing layer between the electrically conductive substrate and the photosensitive layer, and it is more preferred that the subbing layer contains an inorganic particle. By providing the subbing layer, injection of an electric charge into the photosensitive layer from the support can be prevented to favor no occurrence of an image quality defect such as black spot and white spot, the adhesion between the electrically conductive substrate and the photosensitive layer is enhanced to improve the durability and when an inorganic particle is contained in the subbing layer, stabilization of the environmental characteristics and cycle characteristics and prevention of Moire fringes can be attained.

Also, the subbing layer plays a great role with respect to the prevention of image quality defect and is an important layer for reducing the image quality defect ascribable to the defect or fouling of the substrate or to the film coating defect or unevenness in the photosensitive layer. The subbing layer is preferably formed by dispersing the above-described surface coat-treated metal oxide particle, the binder and the additive to prepare a coating solution for subbing layer and applying the coating solution onto the electrically conductive substrate.

### (1) Metal Oxide Particle

In this exemplary embodiment, an electrically conductive powder having an average particle diameter of 0.5 μm or less is preferably used as the metal oxide particle. The particle diameter as used herein means the average primary particle diameter. The subbing layer must have appropriate resistance so as to obtain the leak resistance and for this purpose, the metal oxide particle preferably has a powder resistance of approximately from 10² to 10¹¹ Ωcm. In particular, a metal oxide particle such as titanium oxide, zinc oxide and tin oxide having the above-described resistance value is preferably used. Within the range above, excellent leak resistance is obtained, and an increase of the residual potential is suppressed. One kind of a metal oxide particle may be used alone, or two or more kinds may be mixed and used.

By performing surface-treating the metal oxide particle with a surface treating agent, the wetting and compatibility of the metal oxide particle with the resin are improved and the dispersibility in the resin is advantageously enhanced. The “surface treatment of the metal oxide particle” as used in this exemplary embodiment means to cover at least a part of the metal oxide particle surface by reacting a surface treating agent with the metal oxide particle surface.

Examples of the compound used as the surface treating agent in this exemplary embodiment include, but are not particularly limited to, an organozirconium compound such as zirconium chelate compound, zirconium alkoxide compound and zirconium coupling agent; an organotitanium compound such as titanium chelate compound, titanium alkoxide compound and titanate coupling agent; an organoaluminum compound such as aluminum chelate compound and aluminum coupling agent; a reactive organometallic compound such as antimony alkoxide compound, germanium alkoxide compound, indium alkoxide compound, indium chelate compound, manganese alkoxide compound, manganese chelate compound, tin alkoxide compound, tin chelate compound, aluminum silicon alkoxide compound, aluminum titanium alkoxide compound and aluminum zirconium alkoxide compound; and a silane coupling agent. Among these organometallic compounds, preferred are an organozirconium compound, an organotitanyl compound and an organoaluminum compound. In particular, a zirconium alkoxide compound, a zirconium chelate compound, a titanium alkoxide compound, a titanium chelate compound and/or a silane coupling agent are preferred because the residual potential is low and good electrophotographic characteristics are exhibited. Above all, a silane coupling agent is more preferred in the light of enhancing the electric characteristics, enhancing the environmental stability and enhancing the image quality.

The silane coupling agent may be any silane coupling agent as long as desired photoreceptor characteristics are obtained. Specific examples of the silane coupling agent include, but are not limited to, vinyltrimethoxysilane, γ-methacryloxypropyl-tris(β-methoxyethoxy)silane, β-(3,4-epoxycyclohexyl)ethyltrimethoxysilane, γ-glycidoxypropyl-trimethoxysilane, vinyltriacetoxysilane, γ-mercapto-propyltrimethoxysilane, γ-aminopropyltriethoxysilane, N-β-(aminoethyl)-γ-aminopropyltrimethoxysilane, N-β-(aminoethyl)-γ-aminopropylmethylmethoxysilane, N,N-bis(β-hydroxyethyl)-γ-aminopropyltriethoxysilane, and γ-chloropropyltrimethoxysilane. Also, two or more kinds of these silane coupling agent may be mixed and used.

The surface treatment of the metal oxide particle may also be performed in a solvent.

The solvent may be arbitrarily selected from aromatics, halogenated hydrocarbons, ketones, ketone alcohols, ethers and esters. For example, an ordinary organic solvent such as xylene, toluene, methyl cellosolve, ethyl cellosolve, acetone, methyl ethyl ketone, cyclo-hexanone, methyl acetate, ethyl acetate, n-butyl acetate, dioxane, tetrahydrofuran, methylene chloride, chloroform and chlorobenzene may be used. As for the solvent used here, one kind may be used alone, or two or more kinds may be mixed and used.

In this exemplary embodiment, the amount of the surface treating agent based on the metal oxide particle is preferably an amount sufficiently large to obtain the desired electrophotographic characteristics. The electro-photographic characteristics are affected by the amount of the surface treating agent adhering to the metal oxide particle after the surface treatment, and in the case of using a silane coupling agent, the add-on amount thereof is determined by the Si intensity in the fluorescent X-ray analysis and the intensity of the main metal element of the metal oxide. The Si intensity in the fluorescent X-ray analysis is preferably from 1.0×10⁻⁵ to 1.0×10⁻² times the intensity of the main metal element of the metal oxide. Within this range, injection of an electric charge into the photosensitive layer (charge generating layer) from the subbing layer and the residual potential are suppressed and therefore, an excellent image quality is obtained.

The surface-treated metal oxide particle may be subjected to a baking treatment. This treatment allows satisfactory progress of the dehydrating condensation reaction of the surface treating agent. The baking treatment may be performed at an arbitrary temperature condition as long as it is a temperature high enough to obtain the desired electrophotographic characteristics, but in the case of using the above-described surface treating agent, the baking treatment is preferably performed at a temperature of 100° C. or more, more preferably from 150 to 250° C. Within this range, the dehydrating condensation reaction of the surface treating agent can satisfactorily proceed without causing decomposition due to heat. Thereafter, if desired, the surface-treated metal oxide particle is ground. By this treatment, the aggregate of metal oxide particles can be ground and therefore, the dispersibility of the metal oxide particle in the subbing layer can be enhanced.

### (2) Binder

As for the binder (binder resin, binding resin) of the coating solution for the formation of subbing layer, there may be used a known polymer resin compound such as acetal resin (e.g., polyvinyl butyral), polyvinyl alcohol resin, casein, polyamide resin, cellulose resin, gelatin, polyurethane resin, polyester resin, methacrylic resin, acrylic resin, polyvinyl chloride resin, polyvinyl acetate resin, vinyl chloride-vinyl acetate-maleic anhydride resin, silicone resin, silicone-alkyd resin, phenol resin, phenol-formaldehyde resin, melamine resin and urethane resin; a charge transporting resin having a charge transporting group; and an electrically conductive resin such as polyaniline. In particular, a resin insoluble in the coating solvent of the overlying layer is preferably used. Above all, phenol resin, phenol-formaldehyde resin, melamine resin, urethane resin, epoxy resin and the like are preferred. The ratio between the metal oxide particle and the binder in the coating solution for the formation of subbing layer may be arbitrarily set within the range where the desired electrophotographic photoreceptor characteristics are obtained.

### (3) Additive

In the coating solution for the formation of subbing layer, various additives may be used for enhancing the electric characteristics, enhancing the environmental stability and enhancing the image quality. Example of the additive which can be used include an electron transport compound such as quinone compound (e.g., chloranil, bromanil, anthraquinone), tetracyanoquinodimethane compound, fluorenone compound (e.g., 2,4,7-trinitrofluorenone, 2,4,5,7-tetranitro-9-fluorenone), oxadiazole compound (e.g., 2-(4-biphenyl)-5-(4-tert-butylphenyl)-1,3,4-oxadiazole, 2,5-bis-(4-naphthyl)-1,3,4-oxadiazole, 2,5-bis(4-diethylaminophenyl)-1,3,4-oxadiazole), xanthone compound, thiophene compound, and diphenoquinone compound (e.g., 3,3′,5,5′-tetra-tert-butyldiphenoquinone); an electron transport pigment such as polycyclic condensed compound and azo compound; and a known material such as zirconium chelate compound, titanium chelate compound, aluminum chelate compound, titanium alkoxide compound, organotitanium compound and silane coupling agent. Among these, an acceptor compound such as electron transport compound and electron transport pigment is preferred.

Examples of the zirconium chelate compound include zirconium butoxide, zirconium ethyl acetoacetate, zirconium triethanolamine, acetyl acetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compound include tetraisopropyl titanate, tetra-n-butyl titanate, butyl titanate dimer, tetra(2-ethylhexyl) titanate, titanium acetyl acetonate, polytitanium acetyl acetonate, titanium octylene glycolate, titanium lactate ammonium salt, titanium lactate, titanium lactate ethyl ester, titanium triethanolaminate, and polyhydroxytitanium stearate.

Examples of the aluminum chelate compound include aluminum isopropiolate, monobutoxyaluminum diisopropiolate, aluminum butyrate, diethyl acetoacetate aluminum diisopropiolate, and aluminum tris(ethyl acetoacetate).

The silane coupling agent is used for the surface treatment of the metal oxide particle but may be further added as an additive to the coating solution. Specific examples of the silane coupling agent used here include vinyltrimethoxysilane, γ-methacryloxypropyl-tris(β-methoxy-ethoxy)silane, β-(3,4-epoxycyclohexyl)ethyltrimethoxysilane, γ-glycidoxypropyltrimethoxysilane, vinyltriacetoxysilane, γ-mercaptopropyltrimethoxysilane, γ-aminopropyltriethoxy-silane, N-β-(aminoethyl)-γ-aminopropyltrimethoxysilane, N-β-(aminoethyl)-γ-aminopropylmethylmethoxysilane, N,N-bis(β-hydroxyethyl)-γ-aminopropyltriethoxysilane, and γ-chloro-propyltrimethoxysilane.

One of these additives may be used alone, or two or more kinds thereof may be used. Also, the additive may be used as a mixture or polycondensate of a plurality of compounds.

The amount of the additive used in the subbing layer is preferably from 0.1 to 10 wt % based on the amount of the metal oxide particle used. Within this range, the dispersibility and coating suitability are improved and effects such as increase of sensitivity, decrease of residual potential and reduction in fatigue on repeated use are advantageously obtained.

### (4) Solvent

As regards the solvent for preparing the coating solution for the formation of subbing layer, a known organic solvent may be used. For example, the solvent may be arbitrarily selected from an alcohol, an aromatic, a halogenated hydrocarbon, a ketone, a ketone alcohol, an ether and an ester. Examples of the organic solvent which can be used include methanol, ethanol, n-propanol, isopropanol, n-butanol, benzyl alcohol, methyl cellosolve, ethyl cellosolve, acetone, methyl ethyl ketone, cyclo-hexanone, methyl acetate, ethyl acetate, n-butyl acetate, dioxane, tetrahydrofuran, methylene chloride, chloroform, chlorobenzene and toluene. One of these solvents for use in the dispersion may be used alone, or two or more kinds thereof may be mixed and used. In the case of mixing the solvents, any solvent may be used as long as the mixed solvent obtained can dissolve the binder.

### (5) Dispersing Method

As regards the method for dispersing the metal oxide particle in the binder, a method such as roll mill, ball mill, vibration ball mill, attritor, sand mill, colloid mill and paint shaker can be used.

### (6) Coating Method

As for the coating method used in providing the subbing layer, an ordinary method such as blade coating, wire bar coating, spray coating, dip coating, bead coating, air knife coating and curtain coating may be used. The subbing layer is film-formed on the electrically conductive substrate by using the thus-obtained coating solution for the formation of subbing layer. After coating the subbing layer, the solvent in the film is preferably removed through drying in a dryer or by natural drying. The drying temperature and time can be arbitrarily set as required.

### (7) Hardness, Thickness and Surface Roughness of Subbing Layer Surface

The subbing layer preferably has a Vickers hardness of 35 or more. The thickness of the subbing layer is preferably 15 μm or more, more preferably from 20 to 50 μm. Furthermore, in order to prevent the Moire image, the surface roughness of the subbing layer is adjusted to the range from ¼n (n is the refractive index of the overlying layer) to λ of the wavelength λ of the laser used for exposure. For adjusting the surface roughness, a resin particle may also be added to the subbing layer.

Examples of the resin particle which can be used include a silicone resin particle and a crosslinked polymethyl methacrylate resin (PMMA) particle.

Furthermore, the subbing layer may be polished for adjusting the surface roughness. Examples of the polishing method which can be used include buff-polishing, sandblasting, wet honing and grinding.

### <Intermediate Layer>

An intermediate layer may be provided between the subbing layer and the photosensitive layer for enhancing the electric characteristics, enhancing the image quality, enhancing the image quality preservability, enhancing the adhesion of photosensitive layer, or the like. The constituent material of the intermediate layer is not particularly limited and may be arbitrarily selected from synthetic resin, organic or inorganic substance powder, and electron transport substance.

### (1) Compound Contained in Intermediate Layer

Examples of the compound contained in the intermediate layer include a polymer resin compound such as acetal resin (e.g., polyvinyl butyral), polyvinyl alcohol resin, casein, polyamide resin, cellulose resin, gelatin, polyurethane resin, polyester resin, methacrylic resin, acrylic resin, polyvinyl chloride resin, polyvinyl acetate resin, vinyl chloride-vinyl acetate-maleic anhydride resin, silicone resin, silicone-alkyd resin, phenol-formaldehyde resin and melamine resin; and an organometallic compound containing a zirconium, titanium, aluminum, manganese or silicon atom. One of these compounds may be used alone, or a mixture or polycondensate of a plurality of these compounds may be used. Above all, an organometallic compound containing zirconium or silicon is excellent in the performance, for example, the residual potential is low, the change in potential due to environment is small, or the potential is less changed on repeated use.

Examples of the silicon compound include vinyl-trimethoxysilane, γ-methacryloxypropyl-tris(β-methoxy-ethoxy)silane, β-(3,4-epoxycyclohexyl)ethyltrimethoxysilane, γ-glycidoxypropyltrimethoxysilane, vinyltriacetoxysilane, γ-mercaptopropyltrimethoxysilane, γ-aminopropyltriethoxy-silane, N-β-(aminoethyl)-γ-aminopropyltrimethoxysilane, N-β-(aminoethyl)-γ-aminopropylmethylmethoxysilane, N,N-bis(β-hydroxyethyl)-γ-aminopropyltriethoxysilane, and γ-chloropropyltrimethoxysilane. Among these silicon compounds, preferred are vinyltriethoxysilane, vinyltris(2-methoxyethoxysilane), 3-methacryloxypropyltrimethoxysilane, 3-glycidoxypropyltrimethoxysilane, 2-(3,4-epoxycyclo-hexyl)ethyltrimethoxysilane, N-2-(aminoethyl)-3-amino-propyltrimethoxysilane, N-2-(aminoethyl)-3-aminopropyl-methyldimethoxysilane, 3-aminopropyltriethoxysilane, N-phenyl-3-aminopropyltrimethoxysilane, 3-mercaptopropyl-trimethoxysilane, and 3-chloropropyltrimethoxysilane.

Examples of the organozirconium compound include zirconium butoxide, zirconium ethyl acetoacetate, zirconium triethanolamine, acetyl acetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the organotitanium compound include tetraisopropyl titanate, tetra-n-butyl titanate, butyl titanate dimer, tetra(2-ethylhexyl) titanate, titanium acetyl acetonate, polytitanium acetyl acetonate, titanium octylene glycolate, titanium lactate ammonium salt, titanium lactate, titanium lactate ethyl ester, titanium triethanolaminate, and polyhydroxytitanium stearate.

Examples of the organoaluminum compound include aluminum isopropiolate, monobutoxyaluminum diisopropiolate, aluminum butyrate, diethyl acetoacetate aluminum diisopropiolate, and aluminum tris(ethyl acetoacetate).

### (2) Additive

In the intermediate layer, a powder of various organic compounds or inorganic compounds can be added for the purposes of enhancing the electric characteristics, enhancing the light-scattering property, or the like. Examples of the compound which is particularly effective include a white pigment such as titanium oxide, zinc oxide, zinc flower, zinc sulfide, white lead and lithopone, an inorganic pigment as an extender, such as alumina, calcium carbonate and barium sulfate, a polytetrafluoroethylene resin particle (for example, a particle including a resin such as “Teflon (registered trademark), produced by Du Pont), a benzoguanamine resin particle, and a styrene resin particle.

As for the powder added here, a powder having a particle diameter of 0.01 to 2 μm is used. The powder is added, if desired, and the amount added thereof is, in terms of the weight ratio, preferably from 10 to 90 wt %, more preferably from 30 to 80 wt %, based on the total weight of solid contents in the intermediate layer.

In view of reduced residual potential and environ-mental stability, it is also effective to incorporate the above-described electron transport substance, electron transport pigment or the like into the intermediate layer. The intermediate layer plays a role of electrical blocking, in addition to improvement of coatability of the layer (e.g., photosensitive layer) stacked on the upper side of the intermediate layer, and if the thickness is too large, the electrical barrier is excessively intensified and a decrease in the sensitivity or an increase of the electric potential due to repetition is caused. In the case of forming an intermediate layer, the thickness is preferably from 0.1 to 3 μm.

At the preparation of the coating solution for forming the intermediate layer, in the case of adding a powdery substance, the substance is added to a solution having dissolved therein a resin component and dispersed. As for the dispersing method here, a method such as roll mill, ball mill, vibration ball mill, attritor, sand mill, colloid mill and paint shaker can be used. Furthermore, the intermediate layer can be formed by coating a coating solution for the formation of intermediate layer on the electrically conductive substrate and drying the film coating. As for the coating method here, an ordinary method such as blade coating, wire bar coating, spray coating, dip coating, bead coating, air knife coating and curtain coating may be used.

The intermediate layer plays a role as an electrically blocking layer, in addition to the improvement of coatability of the layer formed on the intermediate layer, and if the thickness is too large, the electrical barrier is excessively intensified and a decrease in the sensitivity or an increase of the electric potential due to repetition is caused. Accordingly, in the case of forming an intermediate layer, the thickness is set preferably to a range from 0.1 to 3 μm. After coating the intermediate layer, the solvent in the film is removed through drying in a dryer or by natural drying. The drying temperature and time can be arbitrarily set.

### <Protective Layer>

The protective layer is used for preventing a chemical change of the charge transport layer at the electrical charging of the photoreceptor or more improving the mechanical strength of the photoreceptor. The protective layer can be formed by incorporating an electrically conductive material into an appropriate binder to prepare a coating solution and applying the coating solution on the photosensitive layer.

The protective layer is, for example, a siloxane resin cured film containing a curable resin and a charge transport material, or has a structure that an electrically conductive material is contained in an appropriate binder resin. The curable resin may any known resin but examples thereof include phenol resin, polyurethane resin, melamine resin, diallyl phthalate resin and siloxane resin. In the case of a siloxane resin cured film containing a charge transport material, any material known as a charge transport material can be used. Examples thereof include, but are not limited to, compounds described in JP-A-10-95787, JP-A-10-251277, JP-A-11-32716, JP-A-11-38656, and JP-A-11-236391.

In the case where the protective layer is a film having a structure that an electrically conductive material is contained in an appropriate binder resin, the electrically conductive material is not particularly limited, and examples thereof include a metallocene compound (e.g., N,N′-dimethylferrocene), an aromatic amine compound (e.g., N,N′-diphenyl-N,N′-bis(3-methylphenyl)-(1,1′-biphenyl)-4,4′-diamine), molybdenum oxide, tungsten oxide, antimony oxide, tin oxide, titanium oxide, indium oxide, tin oxide-antimony, a carrier of a solid solution of barium sulfate and antimony oxide, a mixture of the metal oxides above, a mixture of the metal oxide above in a single particle of titanium oxide, tin oxide, zinc oxide or barium sulfate, and a coat of the metal oxide above in a single particle of titanium oxide, tin oxide, zinc oxide or barium sulfate.

As regards the binder for use in the protective layer, a known resin such as polyamide resin, polyvinyl acetal resin, polyurethane resin, polyester resin, epoxy resin, polyketone resin, polycarbonate resin, polyvinyl ketone resin, polystyrene resin, polyacrylamide resin, polyimide resin and polyamideimide resin is used. Also, if desired, these resins may be crosslinked with each other and used.

The protective layer may contain an antioxidant. With respect to specific examples the compound as the antioxidant, examples of the phenol-based antioxidant include 2,6-di-tert-butyl-4-methylphenol, styrenated phenol, n-octadecyl-3-(3′,5′-di-tert-butyl-4′-hydroxyphenyl)-propionate, 2,2′-methylene-bis(4-methyl-6-tert-butylphenol), 2-tert-butyl-6-(3′-tert-butyl-5′-methyl-2′-hydroxybenzyl)-4-methylphenyl acrylate, 4,4′-butylidene-bis(3-methyl-6-tert-butylphenol), 4,4′-thio-bis-(3-methyl-6-tert-butyl-phenol), 1,3,5-tris(4-tert-butyl-3-hydroxy-2,6-dimethyl-benzyl)isocyanurate, tetrakis[methylene-3-(3′,5′-di-tert-butyl-4′-hydroxyphenyl)propionate]-methane and 3,9-bis{2-[3-(3-tert-butyl-4-hydroxy-5-methylphenyl)propionyloxy]-1,1-dimethylethyl}-2,4,8,10-tetraoxaspiro[5,5]undecane.

Examples of the hindered amine-based compound include bis(2,2,6,6-tetramethyl-4-piperidyl)sebacate, bis-(1,2,2,6,6-pentamethyl-4-piperidyl)sebacate, 1-{2-[3-(3,5-di-tert-butyl-4-hydroxyphenyl)propionyloxy]ethyl}-4-[3-(3,5-di-tert-butyl-4-hydroxyphenyl)propionyloxy]-2,2,6,6-tetramethylpiperidine, 8-benzyl-7,7,9,9-tetramethyl-3-octyl-1,3,8-triazaspiro[4,5]-undecane-2,4-dione, 4-benzoyloxy-2,2,6,6-tetramethylpiperidine, a dimethyl succinate-1-(2-hydroxyethyl)-4-hydroxy-2,2,6,6-tetramethyl-piperizine polycondensate, poly-[{6-(1,1,3,3-tetramethyl-butyl)imino-1,3,5-triazine-2,4-diimyl}{(2,2,6,6-tetramethyl-4-piperidyl)imino}hexamethylene{(2,3,6,6-tetramethyl-4-piperidyl)imino}], 2-(3,5-di-tert-butyl-4-hydroxybenzyl)-2-n-butylmalonic acid bis(1,2,2,6,6-pentamethyl-4-piperidyl), and an N,N′-bis(3-aminopropyl)ethylenediamine-2,4-bis[N-butyl-N-(1,2,2,6,6-pentamethyl-4-piperidyl)amino]-6-chloro-1,3,5-triazine condensate.

Examples of the organosulfur-based antioxidant include dilauryl-3,3′-thiodipropionate, dimyristyl-3,3′-thiodipropionate, distearyl-3,3′-thiodipropionate, penta-erythritol-tetrakis(β-lauryl-thiopropionate), ditridecyl-3,3′-thiodipropionate, and 2-mercaptobenzimidazole.

Examples of the organophosphorus-based antioxidant include a known oxidant such as trisnonylphenyl phosphite, triphenyl phosphite and tris(2,4-di-tert-butylphenyl)-phosphite, and an antioxidant having a functional group such as hydroxyl group, amino group or alkoxysilyl group capable of bonding with siloxane resin.

The thickness of the protective layer is preferably from 1 to 20 μm, more preferably from 1 to 10 μm. As regards the method for coating the coating solution for the formation of protective layer, an ordinary method such as blade coating, wire bar coating, spray coating, dip coating, bead coating, air knife coating and curtain coating may be used.

As regards the solvent used in the coating solution for forming the protective layer, one of ordinary organic solvents such as dioxane, tetrahydrofuran, methylene chloride, chloroform, chlorobenzene and toluene may be used alone, or two or more kinds thereof may be mixed and used. A solvent hardly dissolving the photosensitive layer on which this coating solution is coated is preferably used as much as possible.

### (Process Cartridge and Image Forming Apparatus)

The process cartridge in an exemplary embodiment of the present invention and an image forming apparatus in an exemplary embodiment of the present invention, each using the photoreceptor in the exemplary embodiment of the present invention are described below.

The process cartridge of this exemplary embodiment includes the photoreceptor in the exemplary embodiment of the present invention and at least one member selected from an electrically charging device for electrically charging the photoreceptor surface, a latent image forming device for forming a latent image on the photoreceptor surface, a developing device for developing the latent image with a toner to form a toner image, and a cleaning device for cleaning the photoreceptor surface.

Also, the image forming apparatus of this exemplary embodiment includes the photoreceptor in the exemplary embodiment of the present invention, an electrically charging device for electrically charging the photoreceptor surface, a latent image forming device for forming a latent image on the photoreceptor surface, a developing device for developing the latent image with a toner to form a toner image, a transfer device for transferring the toner image onto a transfer medium, and a fixing device for fixing the toner image on a recording medium.

The photoreceptor of this exemplary embodiment can be mounted in an image forming apparatus utilizing emission of near infrared light or visible light, such as laser printer, digital copier, LED printer and laser facsimile, or in a process cartridge equipped to such an image forming apparatus.

As for the laser beam, in order to obtain a high-definition image, a laser oscillating light at 350 to 800 nm is preferred. Also, for obtaining a high-definition image, the spot size of the laser beam is preferably 1×10⁴ μm² or less, more preferably 3×10³ μm² or less.

The photoreceptor of this exemplary embodiment can be used in combination with a one-component or two-component developer or reversal developer. Furthermore, in order to obtain a definite image, the particle diameter of the toner is preferably 10 μm or less, more preferably 8 μm or less. Such a toner can be obtained by a known production method, but a spherical toner obtained by a dissolution suspension method or a polymerization method is particularly preferred. In the toner, a surface lubricant (metal fatty acid salt) or a particle having an abrasive effective may be added.

The photoreceptor of this exemplary embodiment ensures good characteristics with less occurrence of a current leak even when mounted in a contact charging-system image forming apparatus using a charging roller or charging brush.

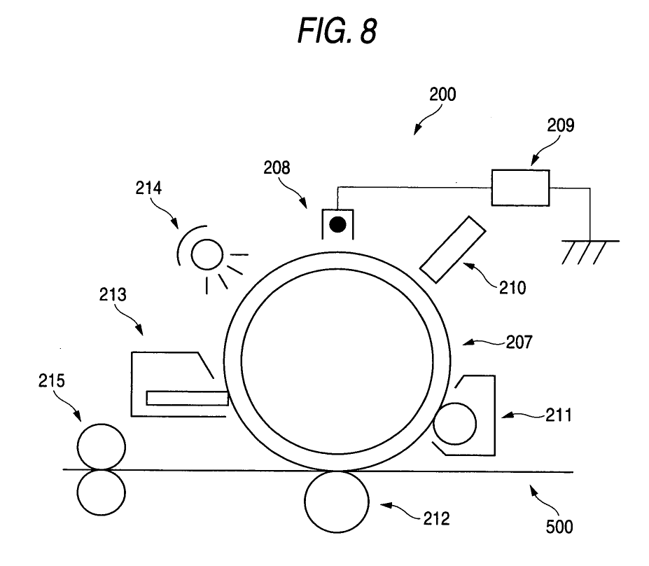

FIG. 8 is a cross-sectional view schematically showing the basic construction in one preferred exemplary embodiment of the image forming apparatus of this exemplary embodiment.

The image forming apparatus 200 shown in FIG. 8 includes a photoreceptor 207, an electrically charging device 208 such as corotron or scorotron for electrically charging the photoreceptor 207 by a corona discharge system, a power source 209 connected to the electrically charging device 208, an exposure device 210 for exposing the photoreceptor 207 electrically charged by the electrically charging device 208 to form an electrostatic latent image, a developing device 211 for developing the electrostatic latent image formed by the exposure device 210 with a toner to form a toner image, a transfer device 212 for transferring the toner image formed by the developing device 211 onto a transfer medium, a cleaning device 213, a destaticizer 214, and a fixing device 215.

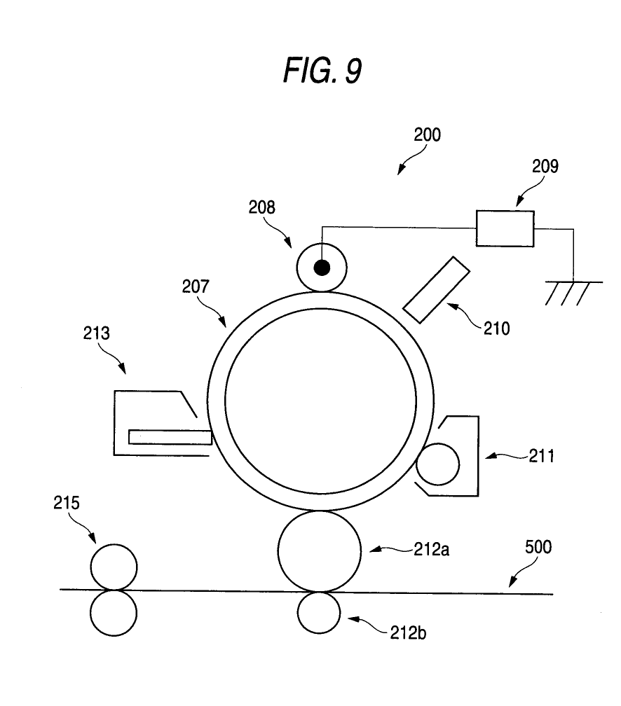

FIG. 9 is a cross-sectional view schematically showing the basic construction in another exemplary embodiment of the image forming apparatus of this exemplary embodiment shown in FIG. 8.

The image forming apparatus 200 shown in FIG. 9 has the same construction as that of the image forming apparatus 200 shown in FIG. 8 except that an electrically charging device 208 of electrically charging the photoreceptor 207 by a contact system is provided and a transfer system by an intermediate transfer method is employed. The photoreceptor has excellent abrasion resistance and therefore, is preferably used in an image forming apparatus employing a contact-system electrically charging device of superposing an AC voltage on a DC voltage. In this case, a destaticizer 214 is sometimes not provided.

The electrically charging means (member for electrical charging) 208 is disposed into contact with the surface of the photoreceptor 207 and uniformly applies a voltage to the photoreceptor, thereby electrically charging the photoreceptor surface to a predetermined potential. Examples of the material which can be used for the electrically charging device 208 include a metal such as aluminum, iron and copper, an electrically conductive polymer material such as polyacetylene, polypyrrole and polythiophene, and a material obtained by dispersing copper iodide, silver iodide, zinc sulfide, silicon carbide, metal oxide or the like in an elastomer material such as polyurethane rubber, silicone rubber, epichlorohydrin rubber, ethylene propylene rubber, acrylic rubber, fluororubber, styrene-butadiene rubber and butadiene rubber.

Examples of the metal oxide include ZnO, SnO₂, TiO₂, In₂O₃, MoO₃, and a composite oxide thereof. An elastomer material imparted with electrical conductivity by incorporating a perchlorate thereinto may also be used for the electrically charging device 208.

Furthermore, a coat layer may be provided on the surface of the electrically charging device 208. Examples of the material for forming the coat layer include N-alkoxymethylated nylon, cellulosic resin, vinylpyridine resin, phenol resin, polyurethane, polyvinyl butyral and melamine resin, and one of these materials may be used alone or several kinds thereof may be used in combination. In addition, an emulsion resin-based material such as acrylic resin emulsion, polyester resin emulsion and polyurethane emulsion, particularly, an emulsion resin synthesized by soap-free emulsion polymerization, may also be used.

In such a resin, an electrically conductive particle may be dispersed for further adjusting the resistivity. An antioxidant may also be incorporated therein for preventing deterioration. In order to improve the film-forming property at the coat layer formation, a leveling agent or surfactant may also be contained in the emulsion resin. Examples of the shape of the contact charging member include roller, blade, belt and brush.

The electrical resistance value of the electrically charging device 208 is preferably from 10¹² to 10¹⁴ Ωcm, more preferably from 10¹² to 10¹² Ωcm. The voltage applied to the contact charging member may be either a direct current or an alternate current. The voltage may also be applied in the form of direct current+alternate current.

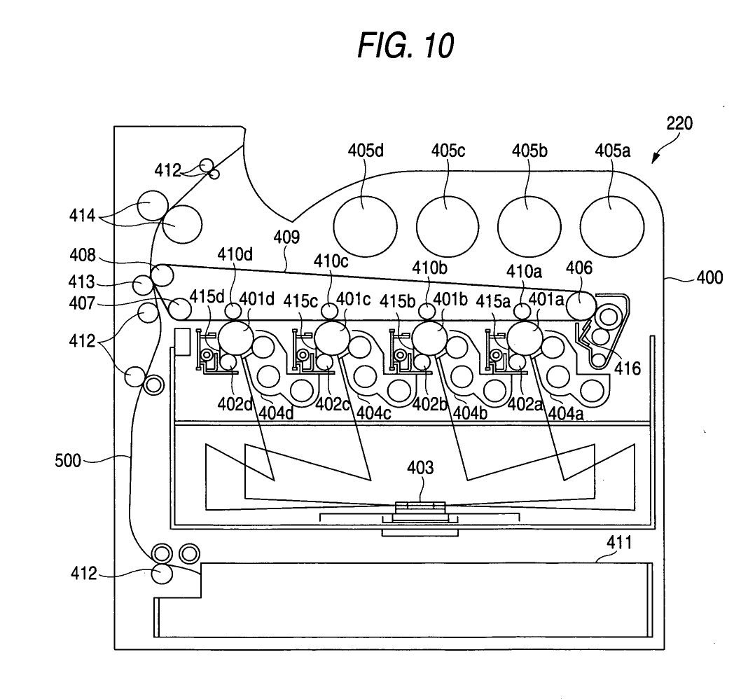

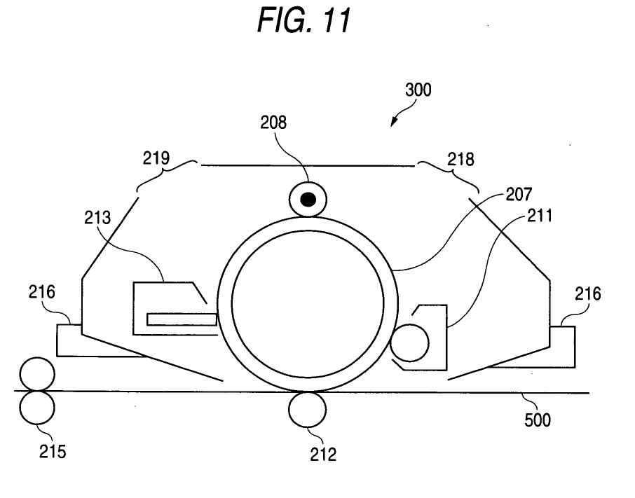

FIG. 10 is a cross-sectional view schematically showing the basic construction in still another embodiment of the image forming apparatus of this exemplary embodiment shown in FIG. 8.

The image forming apparatus 220 shown in FIG. 10 is an image forming apparatus of intermediate transfer system and in a housing 400, four photoreceptors 401a to 401d (for example, the photoreceptor 401a, photoreceptor 401b, photoreceptor 401c and photoreceptor 401d can form images including a yellow color, a magenta color, a cyan color and a black color, respectively) are juxtaposed to each other along the intermediate transfer belt 409.

The photoreceptors 401a to 401d mounted in the image forming apparatus 220 each is the photoreceptor of this exemplary embodiment. For example, a photoreceptor shown in any one of FIGS. 4 to 7 is preferably mounted. The photoreceptors 401a to 401d each can be rotated in a predetermined direction (in a counterclockwise direction on the paper), and electrically charging rolls 402a to 402d, developing devices 404a to 404d, primary transfer rolls 410a to 410d, and cleaning blades 415a to 415d are disposed along the rotation direction. Four color toners of black, yellow, magenta and cyan contained in toner cartridges 405a to 405d can be supplied to the developing devices 404a to 404d, respectively, and the primary transfer rolls 410a to 410d are abutted against the photoreceptors 401a to 401d, respectively, through the intermediate transfer belt 409.

Furthermore, a laser source 403 (latent image forming device (exposure device)) is disposed at the predetermined position in the housing 400, and laser light emitted from the laser source 403 can be irradiated on the surfaces of the photoreceptors 401a to 401d after electrical charging. By virtue of this construction, in the rotation step of the photoreceptors 401a to 401d, the steps of charging, exposure, development, primary transfer and cleaning are sequentially performed, and toner images of respective colors are transferred one on another on the intermediate transfer belt 409.

The intermediate transfer belt 409 is supported by a drive roll 406, a backup roll 408 and a tension roll 407 with a predetermined tension and can be rotated by the rotation of these rolls without generating a deflection. Also, a secondary transfer roll 413 is disposed to abut against the backup roll 408 through the intermediate transfer body 409. The intermediate transfer belt 409 passed between the backup roll 408 and the secondary transfer roll 413 is surface-cleaned, for example, by a cleaning blade 416 disposed in the vicinity of the drive roll 406 and then repeatedly used for the next image forming process.

A tray (recording medium tray) 411 is provided at the predetermined position in the housing 400, and a recording medium 500 such as paper in the tray 411 is conveyed by conveying rolls 412 sequentially between the intermediate transfer belt 409 and the secondary transfer roll 413 and further between two fixing rolls 414 abutted against each other, and then discharged outside of the housing 400.

In the description above, the intermediate transfer belt 409 is used as the intermediate transfer element, but the intermediate transfer element may be a belt like the intermediate transfer belt 409 or may be a drum. In the case of a belt, the resin used as the substrate of the intermediate transfer element may be a conventionally known resin, and examples thereof include a resin material such as polyimide resin, polycarbonate resin (PC), poly-vinylidene fluoride (PVDF), polyalkylene terephthalate (PAT), blend material of ethylene tetrafluoroethylene copolymer (ETFE)/PC, ETFE/PAT or PC/PAT, polyester, polyether ether ketone and polyamide, and a resin material including such a resin material as the main raw material. Furthermore, a resin material and an elastic material may be blended and used.

As for the elastic material, a material obtained by blending one kind or two or more kinds of polyurethane, polyisoprene chloride, NBR, chloropyrene rubber, EPDM, hydrogenated polybutadiene, butyl rubber, silicone rubber and the like may be used. In such a resin material or elastic material used for the substrate, if desired, an electrically conductive agent for imparting electron conductivity or an electrically conductive agent having ion conductivity is added alone or in combination of two or more kinds thereof. Among these, a polyimide resin having dispersed therein an electrically conductive agent is preferred because of its excellent mechanical strength. As regards the electrically conductive agent, an electrically conductive polymer such as carbon black, metal oxide and polyaniline may be used.

In the case where a belt-shaped structure like the intermediate transfer belt 409 is employed as the intermediate transfer element, the thickness of the belt in general is preferably from 50 to 500 μm, more preferably from 60 to 150 μm, but the thickness can be appropriately selected depending on the hardness of the material.

For example, in the case of a belt including a polyimide resin having dispersed therein an electrically conductive agent, as described in JP-A-63-311263, from 5 to 20 wt % of carbon black as the electrically conductive agent is dispersed in a solution of polyamide acid which is a polyimide precursor, the liquid dispersion is spread on a metal drum, and the film after drying is separated from the drum and stretched at a high temperature, whereby a polyimide film can be formed. In general, the film shaping may be performed by a method where a film-forming stock solution, which is a polyamide acid solution having dispersed therein an electrically conductive agent, is poured in a cylindrical mold and formed into a film by centrifugal casting while rotating the cylindrical mold at a rotation number of 500 to 2,000 rpm under heating at a temperature of 100 to 200° C., and the obtained film in a semi-cured state is removed from the mold, laid over an iron core and completely cured by allowing a polyimidation reaction (ring-closing reaction of the polyamide acid) to proceed at a high temperature of 300° C. or more. A method of spreading the film-forming stock solution on a metal sheet to a uniform thickness, heating it at 100 to 200° C. in the same manner as above to remove the major part of the solvent, and then gradually elevating the temperature to 300° C. or more to form a polyimide film may also be used. Furthermore, the intermediate transfer element may have a surface layer.

In the case where a structure having a drum shape is employed as the intermediate transfer element, the substrate is preferably a cylindrical substrate formed of aluminum, stainless steel (SUS), copper or the like. If desired, an elastic layer may be coated on the cylindrical substrate, and a surface layer may be formed on the elastic layer.

FIG. 11 is a cross-sectional view schematically showing the basic construction in one preferred exemplary embodiment of the process cartridge of this exemplary embodiment. In the process cartridge 300, a photoreceptor 207 is combined and integrated with an electrically charging device 208, a developing device 211, a cleaning unit (cleaning device) 213, openings 218 and 219 for exposure, and, if desired, a destaticizer (not shown) by using an attaching rail 216. The process cartridge 300 is removable from the main body of an image forming apparatus including a transfer device 212, a fixing device 215 and other constituent portions not shown and constitutes an image forming apparatus together with the main body of the image forming apparatus. Incidentally, in the process cartridge 300, the transfer system of the transfer device 212 is preferably an intermediate transfer system where a toner image is primarily transferred on an intermediate transfer element (not shown) and the primary transfer image on the intermediate transfer element is secondarily transferred on a transfer medium. Also, the transfer device 212 is preferably an intermediate transfer unit utilizing this intermediate transfer system. Similarly, the transfer device of the image forming apparatus above is also preferably an intermediate transfer unit utilizing the above-described intermediate transfer system.

### EXAMPLES

The exemplary embodiments of the present invention are described in greater detail below based on Examples and Comparative Examples, but the exemplary embodiments of the present invention are not limited to the following Examples. In Examples, the “parts” means “parts by weight”.

### Synthesis Example 1

### Synthesis of I-Type Chlorogallium Phthalocyanine

30 Parts of 1,3-diiminoisoindoline and 9.1 parts of gallium trichloride are reacted in 230 parts of dimethylsulfoxide with stirring at 160° C. for 6 hours to obtain a red violet crystal. This crystal is washed with dimethylsulfoxide, then washed with ion-exchanged water and dried to obtain 28 parts of a crude crystal of I-type chlorogallium phthalocyanine.

### Example 1

### Preparation of First Fluid

1 Part of I-type chlorogallium phthalocyanine prepared above is mixed with 200 parts of dimethylsulfoxide and after stirring at 70° C. for 10 minutes, insoluble matters are filtered through a polytetrafluoroethylene (PTFE)-made membrane filter having a pore size of 0.45 μm. The obtained pigment solution is used as a first fluid.

### <Conversion of Crystal Form of Chlorogallium Phthalo-Cyanine>

The crystal form of the chlorogallium phthalocyanine is then converted using a microreactor shown in FIG. 1. The first fluid and ion-exchanged water as a second fluid are set in a tank 12 and a pump-equipped tank 16, respectively, and fed to the inlet part of a glass-made microreactor 20. In the microreactor 20 set to 40° C. by a temperature control unit, the crystal from of the chlorogallium phthalocyanine is converted and a mixed solution 22 containing the chlorogallium phthalocyanine crystal is recovered in a vessel 24. In the microreactor, the channels L1, L2 and L3 each is set to a width of 300 μm and a depth of 50 μm, and the channel L3 is set to a length of 10 cm. The fluids are fed by setting the flow rate (feed velocity) of the first fluid to 0.5 ml/h and the flow rate (feed velocity) of the second fluid to 1.0 ml/h.

The average particle diameter of the chlorogallium phthalocyanine crystal in the thus-obtained process solution is measured using a dynamic viscoelasticity particle size distribution measuring apparatus (LB500, manufactured by Horiba Ltd.). Also, the particle size distribution is expressed by GSDᵥ (assuming that the particle diameter giving a volume accumulation of 16% when a cumulative distribution is drawn from a small particle diameter with respect to particle size ranges (channels) created by dividing the particle size distribution measured is the volume D_{16V} and the particle diameter giving a volume accumulation of 84% is the volume D_{84V}, the value determined by D_{84V}/D_{16V} is defined as the volume average particle size distribution GSD_{V}) which is an indication generally used.

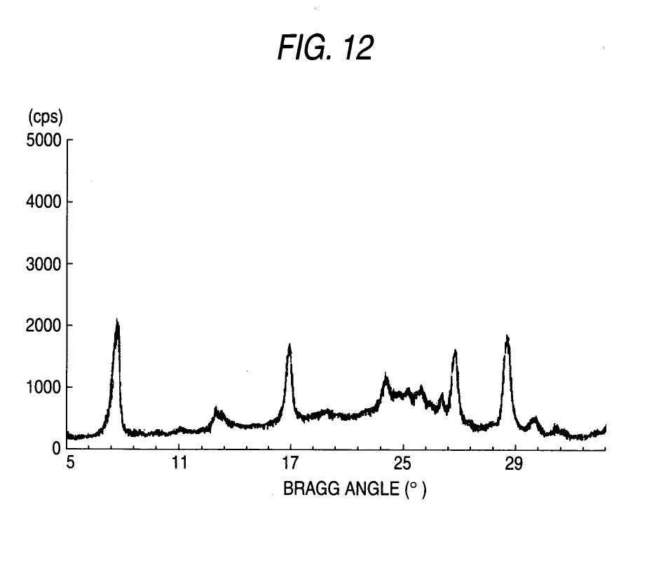

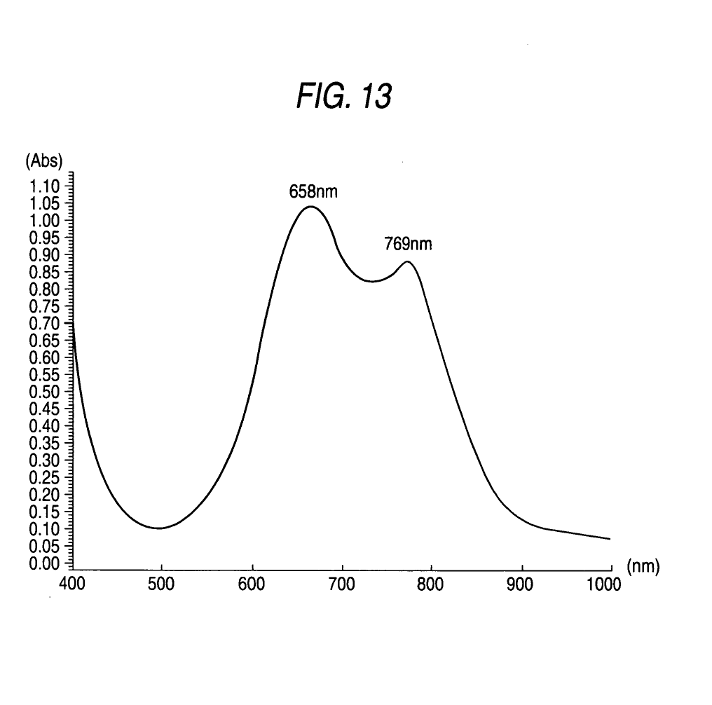

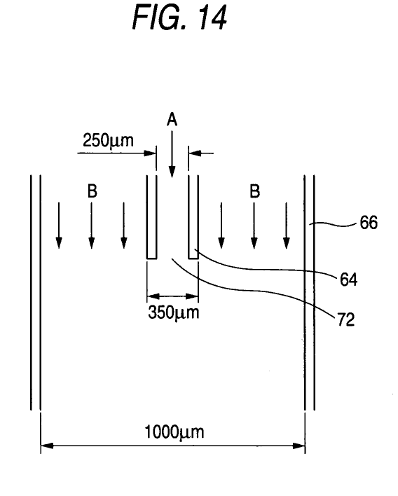

The average particle diameter (median diameter) and GSD_{V} value of the obtained chlorogallium phthalocyanine crystal are shown in Table 1. Also, the obtained process solution containing II-type chlorogallium phthalocyanine crystal is subjected to centrifugal separation to isolate a solid material, the solid material is vacuum-dried at 80° C. for 24 hours by using a vacuum dryer to recover 0.9 parts of II-type chlorogallium phthalocyanine crystal, and this crystal is measured by the powder X-ray diffraction spectrum and the spectral absorption spectrum. FIGS. 12 and 13 show the results obtained.

It is confirmed from FIG. 12 to have a diffraction peak at 7.4°, 16.6°, 25.5° and 28.3° of the Bragg angle (2θ+0.2°) in the X-ray diffraction spectrum, and from FIG. 13 to have a absorption peak at 658 nm and 769 nm in the spectral absorption spectrum.

### <Production of Photoreceptor Sheet>

A photoreceptor is produced as follows by using the obtained II-type chlorogallium phthalocyanine crystal.

First, an aluminum pipe of 40 mm (diameter)×319 mm is prepared as an electrically conductive substrate. Then, 6 parts of polyvinyl butyral (S-LEC BM-1, trade name, produced by Sekisui Chemical Co., Ltd.), 12 parts of blocked isocyanate (Sumidule 3175, trade name, produced by Sumitomo-Bayer Urethane) as a curing agent, 41 parts of zinc oxide having a primary particle diameter of 30 nm (NanoTech ZnO, trade name, produced by C.I. Kasei Co., Ltd.), 1 part of silicone ball (Tospearl 120, trade name, produced by Toshiba Silicones Co., Ltd.), 100 ppm of leveling agent (Silicone Oil SH29PA, trade name, produced by Dow Corning Toray Silicone Co., Ltd.) and 52 parts of methyl ethyl ketone are kneaded for 10 hours in a mill of batch system to prepare a coating solution for the formation of subbing layer.

The coating solution for the formation of subbing layer is dip-coated on a 50 μm-thick aluminum sheet and dried under heating at 150° C. for 30 minutes to form a subbing layer having a film thickness of 20.0 μm.

Subsequently, a solution obtained by dissolving 1 part of vinyl chloride-vinyl acetate copolymer resin (VMCH, trade name, produced by Nippon Unicar Co., Ltd.) in 100 parts of n-butyl acetate is mixed with 1 part of II-type chlorogallium phthalocyanine crystal prepared above and the mixture is dispersed together with 150 parts of glass bead having an exterior diameter of 1.0 mm in a sand mill over 5 hours to prepare a coating solution for the formation of charge generating layer.

The obtained coating solution for the formation of charge charging layer is dip-coated on the subbing layer and dried under heating at 100° C. for 10 minutes to form a charge generating layer having a film thickness of 0.20 μm. Furthermore, 4 parts of N,N′-diphenyl-N,N′-bis(3-methylphenyl)-(1,1′-biphenyl)-4,4′-diamine as a charge transport material, 6 parts of bisphenol Z-type polycarbonate resin having a viscosity average molecular weight of 30,000 as a binder resin, 80 parts of tetrahydrofuran and 0.2 parts of 2,6-di-tert-butyl-4-methylphenol are mixed to prepare a coating solution for the formation of charge transport layer.

The obtained coating solution for the formation of charge transport layer is dip-coated on the surface of the charge generating layer and dried under heating at 120° C. for 40 minutes to form a charge transport layer having a film thickness of 20 μm. In this way, the objective photoreceptor sheet is obtained.

### <Production of Photoreceptor Drum>

The objective photoreceptor drum is produced by sequentially forming a subbing layer, a charge generating layer and a charge transport layer through the same procedure as in the production of the photoreceptor sheet above except that a 1 mm-thick aluminum pipe of 84 mm (diameter)×347 mm surface-roughened by a liquid honing treatment using an abrasive (Alumina Bead CB-A30S (trade name, produced by Showa Titanium Co., Ltd., average particle diameter D₅₀=30 μm)) to have a centerline average roughness Ra of 0.18 μm is used as the electrically conductive support.

The photoreceptor sheet and photoreceptor drum produced above are evaluated as follows. The evaluation results are shown in Tables 1 to 3.

### <Evaluation Test of Electrophotographic Characteristics of Photoreceptor>

### (1) Characteristic Evaluation in Initial Stage of Use

For evaluating electrophotographic characteristics of the obtained photoreceptor sheets of Examples and Comparative Examples, the electrophotographic characteristics are measured by the following procedure.

The photoreceptor sheet is negatively charged through a small area mask of 20 mm in diameter by means of corona discharging at −5.0 kV in an environment of 20° C. and 50% RH by using an electrostatic copying paper testing apparatus (EPA8200, manufactured by Kawaguchi Electric Works Co., Ltd.). Subsequently, light of a halogen lamp converted into light at 780 nm with an interference filter is irradiated to give an illuminance of 5.0 μW/cm² on the surface of the photoreceptor sheet. At this time, the initial surface potential V₀ [V], the half-exposure dose E_{1/2} [μJ/cm²] until the surface potential becomes ½ of V₀, and the dark decay rate (DDR) [%] determined according to {(V₀−V₁)/V₀}×100 where V₁ is a surface potential one second after measuring the surface potential V₀, are measured.

### (2) Evaluation of Repetition Characteristics

The photoreceptor sheet after the above-described operations of electrical charging, exposure and destaticizing are repeated 10,000 times is measured for the surface potential V₀ [V], the half-exposure dose E_{1/2} [μJ/cm²] until the surface potential becomes ½ of V₀, and the dark decay rate (DDR) [%] after the initiation of exposure.

### (3) Evaluation Test of Image Quality

The photoreceptor drums of Examples and Comparative Examples each is mounted in a laser printer having a construction shown in FIG. 11 (DocuPrint 260, manufactured by Fuji Xerox Co., Ltd.), and the image quality is evaluated as follows.

A 1-dot and 1-space halftone image and an overall white image (background image) are output in an environment of 32.5° C./90% RH and by observing the images with an eye and a magnifier, the degree of collapse in the black line part or scattering of the toner is evaluated. Also, the dark potential V_{d} of the photoreceptor is measured.

After outputting 20,000 sheets of an image in which lines of about 2 mm in width are vertically and horizontally printed at intervals of 7 mm, a halftone image and a background image are output in the same manner as above and by observing the images with an eye and a magnifier, the degree of collapse in the black line part or scattering of the toner is evaluated.

Incidentally, the laser printer above employs a roller electric charger (BCR) as the electrically charging unit, ROS with a semiconductor laser of 780 nm as the exposure unit, a two-component reversal development system as the development system, a roller electric charger (BTR) as the transfer unit, and a belt intermediate transfer system as the transfer unit.

### (4) Evaluation of Dispersibility of Charge Generating Material

For evaluating the dispersibility of gallium phthalo-cyanine crystal, a charge generating layer is formed on a glass plate and its dispersed state is observed through a microscope. As for the criteria of dispersibility, “good” means that an aggregate is not observed in the charge generating layer, and “bad” means that an aggregate is observed or the film coating surface is roughened.

Although the evaluations of (1) and (2) above are performed using a photoreceptor sheet and the evaluation of (4) is performed using a charge generating layer formed on a glass plate, the photoreceptor drums used in Examples and Comparative Examples are produced by the same operations as those for the photoreceptor sheet and the charge generating layer formed on a glass plate and despite different shapes, the same evaluation results as those of (1), (2) and (4) are obtained also in the photoreceptor drum.

### Comparative Example 1

20 Parts of I-type chlorogallium phthalocyanine is charged into an alumina-made pot together with 400 parts of alumina-made bead having a diameter of 5 mm. This pot is set in a vibration mill (Model MB-1, manufactured by Chuo Kakohki Co., Ltd.) and the crystal is ground for 180 hours to obtain 18 parts of pulverized chlorogallium phthalo-cyanine. Thereafter, 0.5 parts by weight of the pulverized chlorogallium phthalocyanine is ball-milled in 20 parts of chlorobenzene together with 60 parts of 1 mm-diameter glass bead at room temperature for 24 hours, and the crystal is separated by filtration and washed with 10 parts of methanol to produce a II-type chlorogallium phthalocyanine pigment (performed by referring to Example 4 of JP-A-5-98181).

The obtained pigment is confirmed to have a diffraction peak at 7.4°, 16.6°, 25.5° and 28.3° of the Bragg angle (2θ±0.2°) in the X-ray diffraction spectrum and a absorption peak at 662 nm and 788 nm in the spectral absorption spectrum. The median diameter and GSD_{V} value of the pigment are shown in Table 1.

Also, using the obtained pigment, a photoreceptor sheet and a photoreceptor drum are produced in the same manner as in Example 1 and evaluated in the same manner. The evaluation results are shown in Tables 1 to 3.

### Example 2

The crystal form of I-type chlorogallium phthalo-cyanine is converted using a double-tube microreactor 60 shown in FIGS. 2 and 3.

The double-tube microreactor 60 has a structure where a silica-made tube having an internal diameter of 250 μm is inserted into a glass tube having an internal diameter of 1,000 μm. Using an apparatus shown in FIG. 2, the first fluid 46 prepared in Example 1 which is set in a tank 42 with a stirring unit driven by a motor 48 and a jacket 44 for the temperature control set to 50° C., and ion-exchanged water as a second fluid 58 which is set in a tank 54 with a jacket 56 set to 20° C., are fed to the inlet part of the double-tube microreactor 60 at a flow velocity of 2 ml/h and 20 ml/h, respectively, and after the crystal conversion of I-type chlorogallium phthalocyanine, the process solution is recovered in a vessel 70. The lengths H2 and H1 in the double-tube microreactor 60 are 200 mm and 20 mm, respectively. The channel diameter of each channel is as shown in FIG. 14 which is an enlarged schematic view showing the vicinity of the end 74 of the channel L6 in FIGS. 2 and 3.

The median diameter and GSD_{V} value of the II-type chlorogallium phthalocyanine crystal in the thus-obtained process solution are shown in Table 1. Also, the obtained process solution containing II-type chlorogallium phthalo-cyanine crystal is subjected to centrifugal separation to isolate a solid material, and the solid material is vacuum-dried at 80° C. for 24 hours by using a vacuum dryer to obtain 0.9 parts of II-type chlorogallium phthalocyanine crystal. The obtained II-type chlorogallium phthalocyanine crystal exhibits the same powder X-ray diffraction spectrum as the spectrum of FIG. 12 and exhibits almost the same spectral absorption spectrum as the spectrum of FIG. 13.

Using the obtained pigment, a photoreceptor sheet and a photoreceptor drum are produced in the same manner as in Example 1 and evaluated in the same manner. The evaluation results are shown in Tables 1 to 3.

TABLE 1

| | | | Characteristics of Photoreceptor | | | | |
|---|---|---|---|---|---|---|---|
| | Charge | | | | | Characteristics | |
| | Generating | | Initial | | | after | |
| | Material | | Characteristics | | | 10,000 Sheets | |
| | Median | | | E_{1/2} | | E_{1/2} | |
| | Diameter | | V₀ | (μJ/ | DDR | (μJ/ | DDR |
| | (μm) | GSDᵥ | (−V) | cm²) | (%) | cm²) | (%) |
| Example 1 | 0.11 | 1.43 | 492 | 0.72 | 8.9 | 0.89 | 12.6 |
| Comparative | 0.33 | 3.19 | 473 | 0.88 | 8.1 | 1.81 | 21.8 |
| Example 1 | | | | | | | |
| Example 2 | 0.08 | 1.29 | 496 | 0.76 | 8.7 | 0.92 | 10.5 |

TABLE 2

| | Charge Generating | | | |
|---|---|---|---|---|
| | Material | | | |
| | Spectral Absorption | | Photoreceptor | |
| | Spectrum | | Image | Dispersibility of Film |
| | (nm) | (nm) | Quality | Coating |
| Example 1 | 658 | 769 | good | good |
| Comparative | 672 | 788 | bad | bad |
| Example 1 | | | | |
| Example 2 | 655 | 762 | good | good |

TABLE 3

| | Image Quality Evaluation Test | | | | | |
|---|---|---|---|---|---|---|
| | | | | Characteristics after Output of | | |
| | Initial Characteristics | | | 10,000 Sheets | | |
| | Dark | | | Dark | | |
| | Potential Vd | Halftone | Background | Potential Vd | Halftone | Background |
| | (−V) | Image | Image | (−V) | Image | Image |
| Example 1 | 584 | good | good | 562 | good | good |
| Comparative | 573 | good | bad | 486 | bad | bad |
| Example 1 | | | | | | |
| Example 2 | 590 | good | good | 543 | good | good |

### Synthesis Example 2

### Synthesis of I-Type Hydroxygallium Phthalocyanine

Parts of 1,3-diiminoisoindoline and 9.1 parts of gallium trichloride are reacted in 230 parts of dimethylsulfoxide with stirring at 160° C. for 6 hours to obtain a red violet crystal. This crystal is washed with dimethylsulfoxide, then washed with ion-exchanged water and dried to obtain 28 parts of a crude crystal of I-type chlorogallium phthalocyanine.

2 Parts of the obtained crude crystal of I-type chlorogallium phthalocyanine is thoroughly dissolved in 80 parts of sulfuric acid (concentration: 97%) at 65° C., and the resulting solution is cooled to 25° C. and added dropwise to a mixed solution containing 150 parts of 25% aqueous ammonia and 100 parts of ion-exchanged water. The crystal precipitated is collected by filtration, washed with ion-exchanged water and dried to obtain 1.8 parts of I-type hydroxygallium phthalocyanine.

### Example 3

### Preparation of First Fluid

1 Part of I-type hydroxygallium phthalocyanine prepared above is mixed with 200 parts of N-methyl-2-pyrrolidone while stirring and dissolved using an ultrasonic washing machine, and insoluble matters are then filtered through a PTFE-made filter having a pore size of 0.45 μm. The obtained pigment solution is used as a first fluid.

### <Crystal Conversion of Hydroxygallium Phthalocyanine Pigment>

Crystal conversion of the hydroxygallium phthalo-cyanine is then performed using a microreactor shown in FIG. 1. The first fluid and ion-exchanged water as a second fluid are set in a tank 12 and a pump-equipped tank 16, respectively, and fed to the inlet part of a glass-made microreactor 20. In the microreactor 20 set to 40° C. by a temperature control unit, the crystal from of the hydroxygallium phthalocyanine is converted and a mixed solution 22 containing the hydroxygallium phthalocyanine crystal is recovered in a vessel 24. In the microreactor, the channels L1, L2 and L3 each is set to a width of 300 μm and a depth of 50 μm, and the channel L3 is set to a length of 10 cm. The fluids are fed by setting the flow rate (feed velocity) of the first fluid to 0.5 ml/h and the flow rate (feed velocity) of the second fluid to 1.0 ml/h.

The average particle diameter of the hydroxygallium phthalocyanine pigment in the thus-obtained process solution is measured using a dynamic viscoelasticity particle size distribution measuring apparatus (LB500, manufactured by Horiba Ltd.).

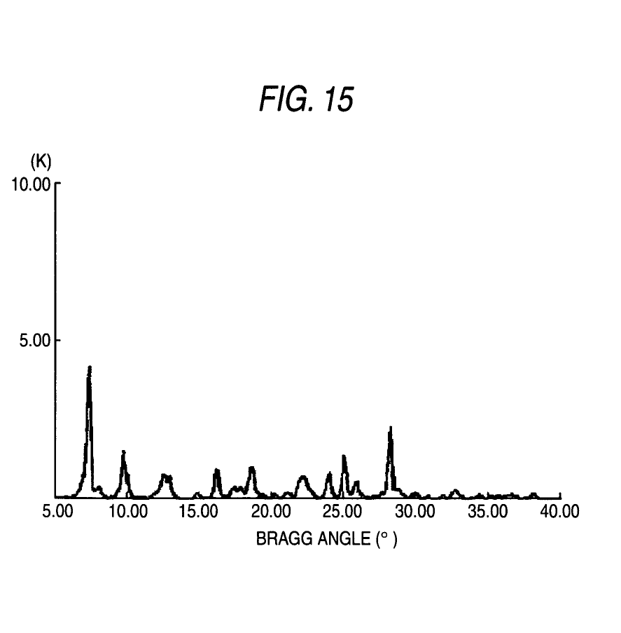

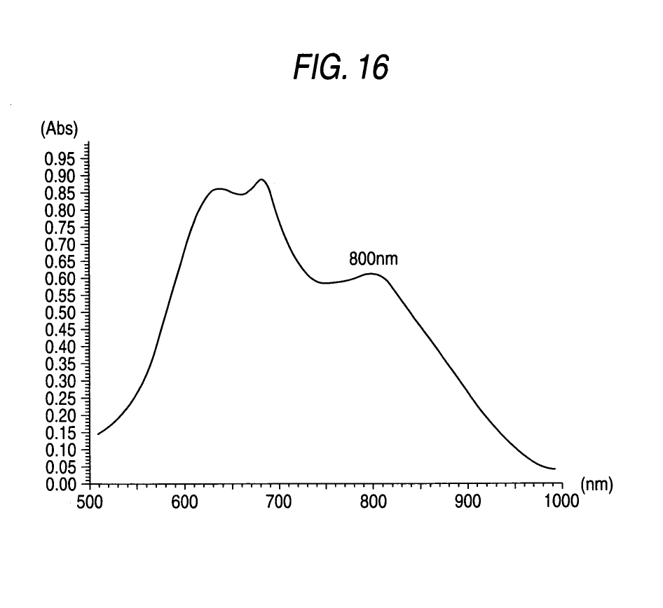

The average particle diameter and GSD_{V} value of the obtained hydroxygallium phthalocyanine crystal are shown in Table 4. Also, the obtained process solution containing V-type hydroxygallium phthalocyanine crystal is subjected to centrifugal separation to isolate a solid material, the solid material is vacuum-dried at 80° C. for 24 hours by using a vacuum dryer to recover 0.9 parts of a hydroxy-gallium phthalocyanine pigment, and this pigment is measured by the powder X-ray diffraction spectrum and the spectral absorption spectrum. FIGS. 15 and 16 show the results obtained.

It is confirmed from FIG. 15 to have a diffraction peak at 7.5°, 9.9°, 12.5°, 16.3°, 18.6°, 25.1° and 28.3° of the Bragg angle (2θ±0.2°) in the X-ray diffraction spectrum, and from FIG. 16 to have a absorption peak at 800 nm in the spectral absorption spectrum.

### <Production of Photoreceptor Sheet>

A photoreceptor is produced as follows by using the obtained V-type hydroxygallium phthalocyanine crystal.

First, an aluminum pipe of 40 mm (diameter)×319 mm is prepared as an electrically conductive substrate. Then, 6 parts of polyvinyl butyral (S-LEC BM-1, trade name, produced by Sekisui Chemical Co., Ltd.), 12 parts of blocked isocyanate (Sumidule 3175, trade name, produced by Sumitomo-Bayer Urethane) as a curing agent, 41 parts of zinc oxide having a primary particle diameter of 30 nm (NanoTech ZnO, trade name, produced by C.I. Kasei Co., Ltd.), 1 part of silicone ball (Tospearl 120, trade name, produced by Toshiba Silicones Co., Ltd.), 100 ppm of leveling agent (Silicone Oil SH29PA, trade name, produced by Dow Corning Toray Silicone Co., Ltd.) and 52 parts of methyl ethyl ketone are kneaded for 10 hours in a mill of batch system to prepare a coating solution for the formation of subbing layer. The coating solution for the formation of subbing layer is dip-coated on a 50 μm-thick aluminum sheet and dried under heating at 150° C. for 30 minutes to form a subbing layer having a film thickness of 20.0 μm.

Subsequently, a solution obtained by dissolving 1 part of vinyl chloride-vinyl acetate copolymer resin (VMCH, trade name, produced by Nippon Unicar Co., Ltd.) in 100 parts of n-butyl acetate is mixed with 1 part of V-type hydroxygallium phthalocyanine crystal prepared above and the mixture is dispersed together with 150 parts of glass bead having an exterior diameter of 1.0 mm in a sand mill over 5 hours to prepare a coating solution for the formation of charge generating layer. The obtained coating solution for the formation of charge charging layer is dip-coated on the subbing layer and dried under heating at 100° C. for 10 minutes to form a charge generating layer having a film thickness of 0.20 μm. Furthermore, 4 parts of N,N′-diphenyl-N,N′-bis(3-methylphenyl)-(1,1′-biphenyl)-4,4′-diamine as a charge transport material, 6 parts of bisphenol Z-type polycarbonate resin having a viscosity average molecular weight of 30,000 as a binder resin, 80 parts of tetrahydrofuran and 0.2 parts of 2,6-di-tert-butyl-4-methylphenol are mixed to prepare a coating solution for the formation of charge transport layer.

The obtained coating solution for the formation of charge transport layer is dip-coated on the surface of the charge generating layer and dried under heating at 120° C. for 40 minutes to form a charge transport layer having a film thickness of 20 μm. In this way, the objective photoreceptor sheet is obtained.

### <Production of Photoreceptor Drum>

The objective photoreceptor drum is produced by sequentially forming a subbing layer, a charge generating layer and a charge transport layer through the same procedure as in the production of the photoreceptor sheet above except that a 1 mm-thick aluminum pipe of 84 mm (diameter)×347 mm surface-roughened by a liquid honing treatment using an abrasive (Alumina Bead CB-A30S (trade name, produced by Showa Titanium Co., Ltd., average particle diameter D₅₀=30 μm)) to have a centerline average roughness Ra of 0.18 μm is used as the electrically conductive support.

Using the obtained photoreceptor sheet and photo-receptor drum, the same evaluations as in Example 1 are performed. The evaluation results are shown in Tables 4 to 6.

### Comparative Example 2

The I-type hydroxygallium phthalocyanine pigment obtained by an acid pasting treatment in Synthetic Example 2 is ground in an automatic mortar for 5.5 hours to obtain an amorphous pigment. A treatment of converting the crystal form by milling 5.0 parts of the amorphous pigment, 150 parts of dimethylformamide and glass beads having a diameter of 1 mm is performed for 24 hours to obtain 4.5 parts of a hydroxygallium phthalocyanine pigment, and various tests and evaluations of the pigment are performed. The obtained hydroxygallium phthalocyanine pigment is confirmed to have a diffraction peak at 7.5°, 9.9°, 12.5°, 16.3°, 18.6°, 25.1° and 28.3° of the Bragg angle (2θ±0.2°) in the X-ray diffraction spectrum and a absorption peak at 856 nm in the spectral absorption spectrum. The median diameter and GSDᵥ value of the pigment are shown in Table 4.

Also, using the obtained pigment, a photoreceptor sheet and a photoreceptor drum are produced in the same manner as in Example 3 and evaluated in the same manner as in Example 1. The evaluation results are shown in Tables 4 to 6.

### Example 4

The crystal form of I-type hydroxygallium phthalo-cyanine is converted using a double-tube microreactor 60 shown in FIGS. 2 and 3.

The double-tube microreactor 60 has a structure where a silica-made tube having an internal diameter of 250 μm is inserted into a glass tube having an internal diameter of 1,000 μm. Using an apparatus shown in FIG. 2, the first fluid 46 prepared in Example 3 which is set in a tank 42 with a stirring unit driven by a motor 48 and a jacket 44 for the temperature control set to 50° C., and ion-exchanged water as a second fluid 58 which is set in a tank 54 with a jacket 56 set to 20° C., are fed to the inlet part of the double-tube microreactor 60 at a flow velocity of 2 ml/h and 20 ml/h, respectively, and after the crystal conversion of I-type hydroxygallium phthalocyanine, the process solution is recovered in a vessel 70. The lengths H2 and H1 in the double-tube microreactor 60 are 200 mm and 20 mm, respectively. The channel diameter of each channel is as shown in FIG. 14 which is an enlarged schematic view showing the vicinity of the end 74 of the channel L6 in FIGS. 2 and 3.

The median diameter and GSD_{V} value of the V-type hydroxygallium phthalocyanine crystal in the thus-obtained process solution are shown in Table 4. Also, the obtained process solution containing V-type hydroxygallium phthalo-cyanine crystal is subjected to centrifugal separation to isolate a solid material, and the solid material is vacuum-dried at 80° C. for 24 hours by using a vacuum dryer to obtain 0.9 parts of V-type hydroxygallium phthalocyanine crystal. The obtained V-type hydroxygallium phthalocyanine crystal exhibits the same powder X-ray diffraction spectrum as the spectrum of FIG. 15 and exhibits almost the same spectral absorption spectrum as the spectrum of FIG. 16.

Using the obtained pigment, a photoreceptor sheet and a photoreceptor drum are produced in the same manner as in Example 3 and evaluated in the same manner as in Example 1. The results are shown in Tables 4 to 6.

TABLE 4

| | | | Characteristics of Photoreceptor | | | | |
|---|---|---|---|---|---|---|---|
| | Charge | | | | | Characteristics | |
| | Generating | | Initial | | | after | |
| | Material | | Characteristics | | | 10,000 Sheets | |
| | Median | | | E_{1/2} | | E_{1/2} | |
| | Diameter | | V₀ | (μJ/ | DDR | (μJ/ | DDR |
| | (μm) | GSDᵥ | (−V) | cm²) | (%) | cm²) | (%) |
| Example 3 | 0.09 | 1.34 | 490 | 0.42 | 8.8 | 0.63 | 11.6 |
| Comparative | 0.33 | 3.19 | 470 | 0.51 | 9.4 | 1.32 | 15.7 |
| Example 2 | | | | | | | |
| Example 4 | 0.08 | 1.25 | 491 | 0.43 | 8.4 | 0.68 | 10.5 |

TABLE 5

| | Charge Generating | | |
|---|---|---|---|
| | Material | | |
| | Spectral Absorption | Photoreceptor | |
| | Spectrum | Image | Dispersibility of Film |
| | (nm) | Quality | Coating |
| Example 3 | 800 | good | good |
| Comparative | 856 | bad | bad |
| Example 2 | | | |
| Example 4 | 796 | good | good |

TABLE 6

| | Image Quality Evaluation Test | | | | | |
|---|---|---|---|---|---|---|
| | | | | Characteristics after Output of | | |
| | Initial Characteristics | | | 10,000 Sheets | | |
| | Dark | | | Dark | | |
| | Potential Vd | Halftone | Background | Potential Vd | Halftone | Background |
| | (−V) | Image | Image | (−V) | Image | Image |
| Example 3 | 580 | good | good | 557 | good | good |
| Comparative | 567 | good | bad | 471 | bad | bad |
| Example 2 | | | | | | |
| Example 4 | 583 | good | good | 546 | good | good |

What is claimed is:

1. A gallium phthalocyanine crystal having a peak of spectral absorption spectrum within a wavelength range of from about 760 nm to about 773 nm or within a wavelength range of from about 790 nm to about 809 nm.

2. The gallium phthalocyanine crystal according to claim 1, wherein
the peak in the wavelength range of from about 760 nm to about 773 nm or from about 790 nm to about 809 nm is a first or second largest peak in a range of from about 600 nm to 900 nm.

3. The gallium phthalocyanine crystal according to claim 1, having a particle diameter of from about 10 nm to about 300 nm.

4. The gallium phthalocyanine crystal according to claim 1, having a volume average particle size distribution GSD_{V} of from about 1.0 to about 3.0.

5. The gallium phthalocyanine crystal according to claim 1, which is a II-type chlorogallium phthalocyanine crystal having a peak of spectral absorption spectrum in the wavelength range of from about 760 nm to about 773 nm.

6. The gallium phthalocyanine crystal according to claim 1, which is a V-type hydroxygallium phthalocyanine crystal having a peak of spectral absorption spectrum in the wavelength range of from about 790 nm to about 809 nm.

7. The gallium phthalocyanine crystal according to claim 6, wherein
the V-type hydroxygallium phthalocyanine crystal has a peak of spectral absorption spectrum in the wavelength range of from about 791 nm to about 805 nm.

8. A photoreceptor comprising a functional layer containing the gallium phthalocyanine crystal according to claim 1.

9. The photoreceptor according to claim 8, further comprising:
an electrically conductive substrate,
wherein
the functional layer is a photosensitive layer that comprises a charge generating layer and a charge transport layer, and
the charge generating layer contains the gallium phthalocyanine crystal.

10. The photoreceptor according to claim 9, further comprising:
a subbing layer that contains at least a metal oxide particle and a binder.

11. The photoreceptor according to claim 10, further comprising:
a protective layer that prevents a chemical change of the charge transport layer at the time of electrically charging the photoreceptor or improves a mechanical strength of the photosensitive layer.

12. The photoreceptor according to claim 10, further comprising:
an intermediate layer that is provided between the photosensitive layer and the subbing layer, and that enhances electric characteristics of the photoreceptor, enhances an image quality, or enhances an adhesion of the photosensitive layer.

13. A process cartridge comprising:
the photoreceptor according to claim 8; and
at least one member selected from the group consisting of an electrically charging device that electrically charges a surface of the photoreceptor, a latent image forming device that forms a latent image on the surface of the photoreceptor, a developing device that develops the latent image with a toner to form a toner image, and a cleaning device that cleans the surface of the photoreceptor.

14. An image forming apparatus comprising:
the photoreceptor according to claim 8;
an electrically charging device that electrically charges a surface of the photoreceptor;
a latent image forming device that forms a latent image on the surface of the photoreceptor;
a developing device that develops the latent image with a toner to form a toner image;
a transfer device that transfers the toner image onto a transfer medium; and
a fixing device that fixes the toner image on a recording medium.

15. A process for producing a gallium phthalocyanine crystal, comprising:
dissolving a gallium phthalocyanine compound in a good solvent to prepare a solution; and
mixing the prepared solution with a bad solvent for the gallium phthalocyanine compound in a microchannel to obtain a crystal of the gallium phthalocyanine compound.

16. The process according to claim 15, wherein
the good solvent comprises one solvent selected form the group consisting of N-methylpyrrolidone, dimethyl sulfoxide, dimethylacetamide, dimethylsulfoamide and N,N-dimethylformamide.

17. The process according to claim 15, wherein
the good solvent is from about 20 parts by weight to about 10,000 parts by weight per 1 part by weight of the gallium phthalocyanine compound.

18. The process according to claim 15, wherein
the bad solvent comprises one solvent selected form the group consisting of hexane, benzene, toluene, water, acetone, methyl ethyl ketone and methyl isobutyl ketone.

19. The process according to claim 15, wherein
the mixing is performed in a double-tube microreactor.
